(19) United States
(12) Patent Application Publication
(10) Pub. No.: US 2026/0339809 A1
(43) Pub. Date: Oct. 29, 2026

(54) MANAGING VIRTUAL PROCESSING UNIT MAPPING IN A COMPUTING SYSTEM

(71) Applicant: Intel Products IP LLC, Santa Clara, CA (US)

(72) Inventors: Aravindan MUTHUKUMAR, TUTICORIN (IN); Paras CHANDRA, Farrukhabad (IN); Satwik KARRA, Rajahmundry (IN); Jaishankar RAJENDRAN, Bangalore (IN); Prakhar VISHWAKARMA, Bangalore (IN)

(21) Appl. No.: 19/719,186

(22) Filed: Jun. 25, 2026

(51) Int. Cl. G06F 11/34; G06F 9/50

(52) U.S. Cl. CPC G06F 11/3433; G06F 9/5077; G06F 11/3452

(57) ABSTRACT

An apparatus including: a memory configured to store a graph data structure comprising nodes of a first type representing physical processing units and nodes of a second type representing virtual processing units within a virtualized computing environment, and edges connecting nodes of the graph data structure; and a processor configured to: assign edge weights to the edges based on hardware telemetry data collected during execution of a workload in the virtualized computing environment; and process the graph data structure comprising the edge weights using a graph neural network to determine a placement quality indicator for a mapping of at least one virtual processing unit of the virtual processing units to at least one physical processing unit of the physical processing units.

### BACKGROUND

Computing systems may execute workloads by instantiating a plurality of virtual machines on shared hardware resources. This operation generally involves a control of a hypervisor operating system. A computing system may include a scheduler that selects, for each virtual machine, a placement on a physical topology, which the physical topology (e.g. a set of hardware resources) can include non-uniform memory access nodes or dies. Under various conditions or limitations, the scheduler may trigger migration of a virtual machine to improve load balancing and resource utilization.

A computing system that supports such virtualization may include an apparatus that cooperates with traditional hypervisor operations. The computing system further provides monitoring, analysis, and outputs that assist with placement and migration decisions for virtual machines. The apparatus may receive platform topology information and performance-related telemetry from the computing system, and the apparatus may output indicators, recommendations, or control data that a management component may use to evaluate migration behavior.

### BRIEF DESCRIPTION OF FIGURES

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 illustrates a block diagram of an example computing system;

FIG. 2 shows a block diagram of an example apparatus described herein;

FIG. 3 illustrates the system integration of a post processing unit within the virtualized computing environment;

FIG. 4 illustrates an example of the two graph compositions of the graph data structure;

FIG. 5 illustrates an example three-phase architecture pipeline;

FIG. 6 depicts an exemplary illustration of a graph neural network;

FIG. 7 illustrates an example of an operational process flow;

FIG. 8 shows schematically an example of a processor and a memory;

FIG. 9 shows an example method.

### DESCRIPTION

Aspects described herein relate generally to resource management in computing systems configured to execute workloads on shared hardware. In particular, aspects of the disclosure relate to evaluating the allocation of computing resources to workloads using data-driven analysis of hardware state information collected during workload execution. The techniques can specifically relate to an apparatus including a memory and a processor configured to manage the migration of workloads between computing resources.

Computing systems employ virtualization to run multiple workloads concurrently on a common set of physical hardware resources. A hypervisor abstracts the physical hardware and presents virtualized resources to software layers executing above it. The hypervisor schedules workloads onto the available physical processors and manages the runtime allocation of memory and processing capacity. The placement of a workload on specific physical resources affects the workload's performance, because factors including memory access patterns, cache utilization, and the topological relationships among processing units differ depending on which physical resources are used for execution.

Schedulers operating within virtualized computing environments make placement decisions based on metrics available at the time of scheduling, such as aggregate processor utilization or available memory capacity. These metrics may not fully characterize the structural relationships within the physical hardware or the dynamic effects that concurrent workloads impose on shared resources. Placement decisions that appear valid under aggregate metrics may nonetheless result in performance degradation caused by, for example, unfavorable memory access distances or contention for shared hardware resources. There exists a need for systematic techniques that evaluate the quality of placement decisions by accounting for the structural organization of the physical hardware and the observed hardware state during execution of the workload.

A virtualized computing environment is a computing system in which a hypervisor abstracts physical hardware resources and presents virtualized resources to one or more workloads executing within virtual machines. The physical hardware of such an environment may be organized according to a non-uniform memory access (NUMA) architecture, in which physical processing units (pCPUs) are grouped into nodes or dies with a shared memory controller. Memory access latency varies depending on whether a processor accesses memory attached to its own node or a remote node on a different socket. Modern processor packages may employ sub-NUMA clustering, which partitions a single physical socket into multiple logical NUMA nodes, each with an associated cache hierarchy. A hypervisor kernel includes a scheduler that maps virtual processing units (vCPUs) of each virtual machine to available physical processing units, with the objective of balancing load and maintaining memory locality.

The scheduler makes placement and migration decisions based on metrics available at scheduling time, including processor load and memory availability. Scheduling conditions may lead to configurations in which virtual processing units are assigned to physical processing units without accounting for cache-level details of the target physical processors. In an example scenario, a transactional workload benchmark executing on a single virtual machine with a large number of virtual processing units generated approximately 18,000 vCPU migration events, a substantial portion of which involved transferring virtual processing units from loaded physical processors to idle ones. Determining whether each such migration was optimal with respect to cache topology would require extensive manual analysis. When a suboptimal placement is made, it may trigger a sequence of further suboptimal decisions, resulting in cumulative performance degradation.

Existing approaches to placement quality analysis include machine learning classifiers that operate on feature vectors derived from virtual machine and physical processor metrics. These approaches treat each physical and virtual processing unit as an independent entity and fail to capture the structural and topological relationships between physical cores and virtual cores, including hyper-threaded contention, last-level cache co-tenancy, and cross-socket NUMA penalties. Graph neural network-based scheduling approaches that model the NUMA topology have also been developed; however, these approaches maintain static edge structures that do not reflect changes in hardware state over time. Both categories of approach produce a binary classification output indicating whether a placement is valid or invalid, without providing root cause identification, quantification of component contributions, or recommendations for alternative placements.

A graph-based representation of the hardware topology and virtual resource assignments provides a structure in which the relationships between physical processing units, virtual processing units, and virtual machine boundaries can be represented simultaneously. When the edge weights of such a graph are derived from hardware telemetry data collected during workload execution and recalibrated at successive time intervals, the graph structure reflects the dynamic state of cache health, execution resource contention, and inter-processor memory sharing. A graph neural network that processes such an adaptively weighted heterogeneous graph can evaluate placement quality by reasoning over the full hardware topology and the current runtime state, enabling diagnostic outputs beyond binary classification.

The term “virtualized computing environment” as described herein may refer to a computing system in which a hypervisor can abstract physical hardware resources and present virtualized resources to one or more workloads executing within virtual machines. The term “physical processing units” as described herein may refer to execution units within the physical hardware of the virtualized computing environment, such as individual processor cores, hyper-threaded logical processors, or processor dies. Examples of physical processing units include individual execution cores within a processor package, hyper-threaded logical processors that share the execution resources of a single physical core, and processor dies within a multi-die processor package. For instance, a processor package implementing simultaneous multithreading may expose two logical processors per physical core, each constituting a distinct physical processing unit for scheduling purposes.

In various aspects described herein, the virtualized computing environment may comprise a non-uniform memory access (NUMA) architecture in which physical processing units are organized into memory access domains, such as NUMA nodes or dies, each associated with a local memory controller and a cache hierarchy. A single physical socket may be partitioned into multiple logical NUMA nodes through sub-NUMA clustering, creating a hierarchy of memory access latencies within a single processor package. The terms “physical processing unit” and “pCPU” are used interchangeably herein.

The term “virtual processing unit” as described herein may refer to a virtualized representation of processing capacity that a hypervisor allocates to a virtual machine. Each virtual processing unit is scheduled for execution on a physical processing unit by a scheduler of the hypervisor. Examples of virtual processing units include the vCPUs allocated by a hypervisor, such as a Linux Kernel-based Virtual Machine (KVM) hypervisor or a VMware ESXi hypervisor, to a guest virtual machine. A virtual machine configured with forty virtual processing units exposes forty vCPUs to the guest operating system, each of which the hypervisor scheduler maps to a physical processing unit for execution. In various aspects described herein, a virtual machine may be allocated a plurality of virtual processing units, and the mapping of those virtual processing units to physical processing units determines the memory access distances and cache sharing relationships experienced by the virtual machine during workload execution. The terms “virtual processing unit” and “vCPU” are used interchangeably herein.

The term “graph data structure” as described herein may refer to a data structure comprising a set of nodes and a set of edges, where each edge connects a pair of nodes and represents a relationship between the entities those nodes correspond to. A graph data structure G=(V, E) is defined by a node set V and an edge set E. The graph data structure may be stored using adjacency matrices, adjacency lists, or edge lists. In various aspects described herein, the graph data structure is a heterogeneous graph comprising nodes of different types that represent different categories of entities within the virtualized computing environment. The term “node” as described herein may refer to a vertex within the graph data structure. Nodes of a first type represent physical processing units and nodes of a second type represent virtual processing units. Each node may be associated with a feature vector derived from data sources specific to the type of entity the node represents. The term “node” in the context of the graph data structure is distinct from the term “NUMA node,” which refers to a memory access domain within the physical hardware as described above.

The term “edge” as described herein may refer to a connection between two nodes in the graph data structure that represents a relationship or interaction between the corresponding entities. In various aspects described herein, edges may be of a first edge type, connecting pairs of nodes of the first type, or of a second edge type, connecting pairs of nodes of the second type. The term “edge weights” as described herein may refer to scalar values associated with edges that quantify the strength or characteristic of the relationship the edge represents. In various aspects described herein, edge weights are adaptive: a processor computes the edge weights based on hardware telemetry data collected during execution of a workload and recalculates the edge weights at successive time intervals so that the edge weights reflect the current state of the hardware during execution.

The term “subgraph” as described herein may refer to a subset of nodes and edges within a graph data structure that corresponds to a logically or physically distinct domain within the virtualized computing environment. In various aspects described herein, a subgraph of a first graph composition may correspond to a respective memory access domain, such as a NUMA node or die, and may comprise nodes of the first type that represent the physical processing units belonging to that memory access domain. A subgraph of a second graph composition may correspond to a respective virtual machine executing in the virtualized computing environment and may comprise nodes of the second type that represent the virtual processing units allocated to that virtual machine.

The term “graph neural network” (GNN) as described herein may refer to a neural network architecture that operates on graph-structured data by processing nodes and edges to generate latent embeddings for each node through a message-passing mechanism, in which a node updates its representation by aggregating information from neighboring nodes. The term “placement quality indicator” as described herein may refer to a metric that indicates the quality of a mapping of one or more virtual processing units to one or more physical processing units. In various aspects described herein, the placement quality indicator may be a composite value derived from multiple placement quality components, including a suitability component, a topology alignment component, and a performance realization component. The placement quality indicator may include a placement quality score (PQS). The term “hardware telemetry data” as described herein may refer to data collected from hardware performance counters, performance monitoring units (PMUs), or kernel interfaces that quantify the runtime behavior of physical processing units. Hardware telemetry data may include, or may be derived from, cache hit and miss rates, instructions per cycle, memory bandwidth utilization, and execution resource contention metrics.

Various aspects described herein involves an apparatus comprising a memory configured to store a graph data structure. The graph data structure comprises nodes of a first type representing physical processing units and nodes of a second type representing virtual processing units within a virtualized computing environment, and edges connecting nodes of the graph data structure. The graph data structure may comprise a first graph composition comprising the nodes of the first type and a second graph composition comprising the nodes of the second type, organized into subgraphs corresponding respectively to memory access domains and to individual virtual machines. This heterogeneous structure captures the hardware topology and the virtual machine boundaries of the virtualized computing environment simultaneously within a single graph representation. The apparatus further comprises a processor configured to assign edge weights to the edges based on hardware telemetry data collected during execution of a workload in the virtualized computing environment. The edge weights may be recalculated at successive time intervals during execution, so that the graph data structure reflects the current state of cache health, execution resource contention, and inter-processor memory sharing at each interval.

In various aspects, the processor is configured to process the graph data structure comprising the edge weights using a graph neural network to determine a placement quality indicator for a mapping of at least one virtual processing unit to at least one physical processing unit. The graph neural network may comprise differentiable neural layers that compute placement quality components from node embeddings and edge weights, wherein the parameters of those layers are jointly trained with the remaining parameters of the graph neural network. This arrangement allows the computation of placement quality components to adapt during training to the relative importance of each hardware telemetry metric for the workload under evaluation, without requiring the edge weight formulas to be treated as fixed external preprocessing steps.

In some aspects, the processor is configured to combine multiple placement quality components using a gated integration in which learned gate values determine the relative contribution of each component to the placement quality indicator. The placement quality components may include a suitability component indicating the suitability of a physical processing unit given its current load and edge weights, a topology alignment component indicating the degree to which virtual processing units of a same virtual machine are mapped to topologically proximate physical processing units, and/or a performance realization component based on a ratio of estimated actual performance to estimated expected performance for the mapping. Additionally, the processor may generate, from a single forward pass of the graph neural network, a root cause classification indicating a category of placement deficiency, a component attribution indicating the contribution of respective metrics to the placement quality indicator, a recommendation of at least one alternative physical processing unit, and a temporal degradation pattern associated with the mapping.

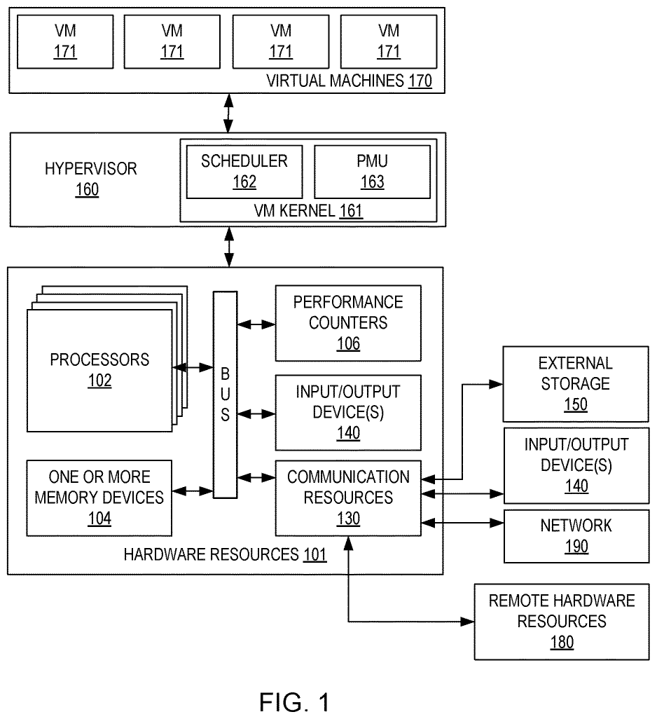

FIG. 1 illustrates a block diagram of an example computing system in accordance with various aspects described herein. The computing system 100 (a computing environment) typically includes a system of interconnected hardware and software resources configured to execute instructions, process data, and manage the allocation of computational capabilities. The computing system 100 may be a server, a workstation, a cluster of servers, a data center, or a cloud computing infrastructure. The computing system 100 includes hardware resources 101, which provide the physical resources for data processing. Hardware resources 101 form a base layer. The hypervisor 160 sits above the hardware resources 101 and interfaces with the processors, memory devices, performance counters, and other hardware resources over the bus and the communication resources. The virtual machines 170 sit above the hypervisor and rely on the hypervisor for access to hardware resources. External storage 150, network 190, external input and output devices 140, and remote hardware resources 180 connect to the hardware resources via the communication resources 130 and input and output devices 140.

The hardware resources 101 may be configured to operate according to a specific architecture, such as a non-uniform memory access architecture, where the physical location of memory relative to a processor affects performance. The hardware resources 101 generally include one or more processors 102, one or more memory devices 104, performance counters 106, a bus, communication resources 130, and one or more input/output devices 140. These components can interact to support the execution of software layers, including a hypervisor 160, virtual machines 170, and/or techniques described herein associated with migration.

The processors 102 represent the computational core of the hardware resources 101. The processors 102 may include one or more physical processing units. Each processing unit among the processors 102 may constitute a central processing unit, a microprocessor, a digital signal processor, or a graphics processing unit configured to perform general-purpose computing tasks. The processors 102 may include, for example, one or a combination of: a central processing unit (CPU), a reduced instruction set computing (RISC) processor, a complex instruction set computing (CISC) processor, a graphics processing unit (GPU), a DSP, an ASIC, an FPGA, a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof.

In an example, the processors 102 may include a plurality of processor sockets located on a mainboard of the computing system 100. A processor socket serves as a physical connector and interface for a single physical processor package. Each physical processor package installed in the processors 102 may contain a single execution core or a plurality of execution cores. When the processors 102 include multi-core processors, each core may independently execute instructions, thereby enabling parallel processing. The processors 102 may support simultaneous multithreading technology, allowing a single physical core to function as multiple logical processors by maintaining separate architectural states for multiple threads of execution. This capability allows the hardware resources 101 to manage a high density of concurrent workloads.

The processors 102 may be configured to operate with internal architectures that partition resources into clusters. For instance, a single processor package within the processors 102 may be logically divided into sub-clusters, where each sub-cluster functions as a distinct non-uniform memory access node. This internal partitioning, such as sub-non-uniform memory access clustering, creates a hierarchy of access latencies even within a single physical socket. The processors 102 may include internal registers, control units, and arithmetic logic units to fetch, decode, and execute instructions defined by an instruction set architecture. The instruction set architecture may be a complex instruction set computing architecture or a reduced instruction set computing architecture. The processors 102 may further include a cache memory hierarchy. The cache memory hierarchy typically includes a level one cache dedicated to each core, a level two cache which may be dedicated or shared, and a level three cache or last-level cache that is typically shared among all cores within a processor or a cluster. The cache memory hierarchy can store frequently accessed data and instructions to reduce the latency associated with accessing the one or more memory devices 104.

In some examples, the one or more processors 102 may execute instructions (e.g., non-transitory computer-readable instructions). Instructions may include software, program code, application(s), applet(s), an app(s), firmware, microcode, machine code, and/or other executable code for causing at least any one of the processors 102 to perform a method, (e.g., any one or more of the methodologies and/or techniques discussed herein). The instructions may reside, completely or partially, within at least one of the processors 102 (e.g., within the processor's cache memory), the memory devices 104, or any suitable combination thereof. Furthermore, any portion of the instructions may be transferred to the computing system 100 from any combination of the input and/or output devices 140 or the external storage 150.

The one or more memory devices 104 provide the main storage for data and instructions that are actively used by the processors 102. The one or more memory devices 104 may include volatile memory technologies, such as dynamic random access memory, synchronous dynamic random access memory, or static random access memory. In high-performance configurations, the one or more memory devices 104 may include high bandwidth memory or double data rate synchronous dynamic random access memory. The one or more memory devices 104 can be organized into physical banks or modules, such as dual in-line memory modules. Within the context of the hardware resources 101, the one or more memory devices 104 may be distributed across different memory controllers associated with specific processors or specific non-uniform memory access nodes.

As examples, the memory devices 104 can be or can include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), multi-level cell (MLC), quad-level cell (QLC), tri-level cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level phase change memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge random access memory (CB-RAM), or spin transfer torque (STT)-MRAM, a spintronic magnetic junction memory based device, a magnetic tunneling junction (MTJ) based device, a domain wall (DW) and spin orbit transfer (SOT) based device, a thyristor based memory device, and/or a combination of any of the aforementioned memory devices, and/or other memory.

The distribution described herein associated with the memory devices 104 can establish the non-uniform memory access topology. A specific range of physical addresses within the one or more memory devices 104 is assigned to a specific physical node, creating a domain of local memory for the processors 102 associated with that physical node. Access to this local memory can provide a desired latency/bandwidth trade-off. Conversely, memory ranges assigned to other nodes are considered remote memory. The one or more memory devices 104 may be cache-coherent, ensuring that data modifications performed by one core are visible to other cores across the system. This coherency may be maintained by hardware protocols, such as a cache coherency protocol, which manages the states of cache lines and coordinates data exchange between the processors 102 and the one or more memory devices 104. The capacity of the one or more memory devices 104 determines the volume of workloads that can reside in the memory simultaneously without necessitating paging to external storage.

The processors 102 and the one or more memory devices 104 communicate via a bus or an interconnect system. The bus represented in FIG. 1 generally illustrates the data pathways within the hardware resources 101. In practice, this bus may include a complex web of point-to-point interconnects, such as the ultra path interconnect or the quickpath interconnect. These interconnects facilitate high-speed data transfer between different processor sockets and between processors and memory controllers. The interconnects possess finite bandwidth and impose latency penalties on data traversing them. When a processor core attempts to access a memory address located in a remote portion of the one or more memory devices 104, the request traverses this interconnect, resulting in remote access latency.

The hardware resources 101 further include performance counters 106. The performance counters 106 may be specialized hardware registers embedded within the processors 102 or within platform circuitry. The performance counters 106 may be configured to track and count designated hardware events that occur during the execution of instructions. These events may include, but are not limited to, the number of instructions retired, the number of central processing unit cycles elapsed, the number of cache hits and misses at various levels of the cache hierarchy, the number of branch mispredictions, and the number of memory access transactions. Specifically, the performance counters 106 may be configured to distinguish between local memory accesses and remote memory accesses.

The performance counters 106 may also track interconnect traffic, such as data packets or snoop requests sent between sockets. The data accumulated by the performance counters 106 can serve as a source of telemetry for analyzing the behavior of the hardware resources 101. This data is accessible to software layers, such as the hypervisor 160 or an operating system, often through a performance monitoring unit interface. Access to the performance counters 106 may enable the precise quantification of resource utilization and the identification of bottlenecks, such as memory bandwidth saturation or excessive cross-node traffic. The performance counters 106 may be programmable, allowing software to select specifically which events to monitor from a predefined set of architectural performance events.

The communication resources 130 enable the hardware resources 101 to exchange data with external entities. The communication resources 130 may include one or more network interface controllers, host bus adapters, or input/output fabric interfaces. The network interface controllers may support various communication standards, such as Ethernet, InfiniBand, or Fibre Channel. The communication resources 130 manage the physical and data link layers of the communication protocols, handling the transmission and reception of data packets. In a virtualized environment, the communication resources 130 may utilize technologies such as single root input/output virtualization to allow multiple virtual machines to share a single physical network interface device directly. The communication resources 130 connect the hardware resources 101 to a network 190. The network 190 may be a local area network, a wide area network, the internet, or a dedicated storage area network. Through the network 190, the computing system 100 may access remote hardware resources 180 and external storage 150. For example, the communication resources 130 may include wired communication components, cellular communication components, Wi-Fi components, and other communication components.

The input/output devices 140 associated with the hardware resources 101 represent local peripheral interfaces and devices. These may include storage controllers, such as redundant array of independent disks controllers, universal serial bus controllers, and interfaces for human interaction devices like keyboards and monitors if the system is configured for direct user interaction. The input/output devices 140 may also include hardware accelerators, such as field-programmable gate arrays or application-specific integrated circuits, installed to offload specific processing tasks from the processors 102. The bus facilitates the communication between the processors 102 and the input/output devices 140, often utilizing standards like peripheral component interconnect express. FIG. 1 also illustrates input/output devices 140 external to the hardware resources 101, which may represent peripherals connected via the communication resources 130 or the network 190, providing flexibility in system configuration.

In some examples, the input and/or output devices 140 may include one or more sensors. The sensors include devices, modules, or subsystems whose purpose are to detect events or changes in its environment and send the information (sensor data) about the detected events to some other a device, module, subsystem, and/or the like. Individual sensors may be exteroceptive sensors (e.g., sensors that capture and/or measure environmental phenomena and/or external states), proprioceptive sensors (e.g., sensors that capture and/or measure internal states of a compute node or platform and/or individual components of a compute node or platform), and/or exproprioceptive sensors (e.g., sensors that capture, measure, or correlate internal states and external states).

The external storage 150 represents persistent data storage repositories located outside the immediate physical chassis of the hardware resources 101. The external storage 150 may include storage area networks, network-attached storage systems, or cloud-based storage services. The external storage 150 may store virtual machine images, application data, and operating system files that are loaded into the one or more memory devices 104 during operation. The connection to the external storage 150 allows for centralized data management and facilitates features such as high availability, where a workload can be restarted on different hardware resources if the primary hardware fails. Access to the external storage 150 is mediated by the communication resources 130 and the protocols of the network 190, such as internet small computer systems interface or non-volatile memory express over fabrics.

The remote hardware resources 180 generally represent other computing nodes or clusters available via the network 190. In a distributed computing system 100, the hardware resources 101 may function as one physical node in a larger cluster, with the remote hardware resources 180 constituting the other physical nodes. The remote hardware resources 180 may possess similar or different configurations compared to the hardware resources 101. The ability to communicate with the remote hardware resources 180 enables distributed processing, where a single large task is decomposed into smaller sub-tasks executed in parallel across multiple machines. It also enables the migration of workloads not just within the non-uniform memory access nodes of the hardware resources 101, but also between entirely different physical servers represented by the hardware resources 101 and the remote hardware resources 180.

The hypervisor 160, also referred to as a virtual machine monitor, includes a software layer that executes on the hardware resources 101. The hypervisor 160 may be configured for creating, running, and managing the virtual machines 170. The hypervisor 160 may abstract the physical details of the processors 102, the one or more memory devices 104, and other hardware components, presenting them as virtualized resources to the virtual machines 170. The hypervisor 160 may be a hypervisor that runs directly on the bare metal hardware, such as VMware ESXi, or one that runs as an application within a host operating system, such as Linux KVM, a kernel-based hypervisor. The hypervisor 160 may have direct control over the hardware or through execution of a processor (e.g., the processors 102).

The hypervisor 160 can include a virtual machine kernel 161. The virtual machine kernel 161 acts as the operating system for the virtualization platform. The virtual machine kernel 161 may manage memory allocation, processor scheduling, and input/output request processing. The virtual machine kernel 161 may operate at the highest privilege level, often referred to as ring zero or root mode, ensuring it has full control over the system resources. Within the virtual machine kernel 161, a scheduler 162 may be provided. The scheduler 162 may be configured for determining which physical processor core runs which virtual central processing unit at any given time. The scheduler 162 implements logic to balance the computational load across the available processors 102. The scheduler 162 monitors the utilization of the physical cores and the demands of the virtual machines 170.

Based on this monitoring, the scheduler 162 can make decisions to migrate virtual machines or specific virtual central processing units from one core or node to another. In an example, the scheduler 162 attempts to maintain non-uniform memory access affinity, where a virtual machine's processing threads are co-located on the same node as its memory pages. However, the scheduler 162 must also respond to contention for processor cycles. If a particular physical node becomes overloaded, the scheduler 162 may decide to move a workload to a less utilized physical node to maintain fairness and responsiveness. The scheduler 162 manages the context switching required to share physical cores among multiple virtual machines, saving the state of a paused virtual machine and restoring the state of the next virtual machine to be executed.

The virtual machine kernel 161 can further include a performance monitoring unit 163. This software performance monitoring unit 163 interfaces with the physical performance counters 106. The performance monitoring unit 163 provides a mechanism for the hypervisor 160 to read and interpret the raw event counts generated by the hardware. It may also virtualize the performance counters 106, allowing the virtual machines 170 to access a subset of performance data relevant to their own execution. The performance monitoring unit 163 collects telemetry data including instructions per cycle, cache miss rates, and memory bandwidth usage. This data is utilized by the scheduler 162 and potentially by other management tools to assess the health and efficiency of the system. The performance monitoring unit 163 may sample the performance counters 106 at defined intervals, creating a time-series of system performance metrics.

The virtual machines 170 represent the workloads executing on the computing system 100. Each virtual machine 171 may be an isolated software container that behaves like a complete physical computer. A virtual machine 171 includes a guest operating system and one or more applications. The guest operating system may be any standard operating system, such as Windows or Linux, which manages the resources allocated to the virtual machine 171 by the hypervisor 160. Each virtual machine 171 is assigned a set of virtual hardware resources, including virtual central processing units, virtual random access memory, and virtual network adapters. The virtual central processing units may be time-sliced representations of the physical processors 102. The virtual random access memory may be mapped to physical pages within the one or more memory devices 104.

The virtual machines 170 execute their instructions on the processors 102 under the supervision of the hypervisor 160. When a virtual machine 171 performs a privileged operation or accesses a hardware resource, the control may trap to the hypervisor 160, which emulates the operation or mediates the access. The isolation provided by the virtual machines 170 ensures that a failure or security breach in one virtual machine 171 does not compromise the host system or other virtual machines 170. The virtual machines 170 are mobile entities within the virtualized environment. The hypervisor 160 can perform a live migration of a virtual machine 171, moving its execution state and memory contents from one physical location to another while the virtual machine 171 continues to run.

The interaction between the scheduler 162 and the virtual machines 170 may be continuous. As the computational demand of a virtual machine 171 fluctuates, the scheduler 162 can dynamically adjust the allocation of processor cycles. If a virtual machine 171 is idle, the scheduler 162 may yield its allocated time to other active workloads. When a virtual machine 171 becomes active, the scheduler 162 may identify an appropriate physical node for its execution. This placement decision may be influenced by the topology of the hardware resources 101. For example, placing a virtual machine 171 on a core that has access to the virtual machine's data in a local cache or local memory node may be preferred over a placement that requires remote access.

In a non-uniform memory access configuration, the latency experienced by a virtual machine 171 can vary based on the placement of its memory pages relative to its execution threads. The hypervisor 160 may obtain physical topology information from firmware tables and operating system interfaces, to understand the physical layout of the hardware. These tables inform the hypervisor 160 for placement decisions (e.g., about which ranges of the one or more memory devices 104 belong to which non-uniform memory access node and the distance or cost associated with accessing them). When the scheduler 162 migrates a virtual machine 171, the memory pages associated with that virtual machine 171 do not necessarily move instantly. They may remain on the source node, creating a situation where the virtual machine 171 is executing on a destination node while accessing memory remotely.

The input/output operations of the virtual machines 170 can be routed through the communication resources 130 and the input/output devices 140. The hypervisor 160 may employ virtual switches to manage network traffic between virtual machines 170 on the same host and between virtual machines 170 and the external network 190. These virtual switches route packets based on media access control addresses or internet protocol addresses. The performance of these input/output operations may also be subject to non-uniform memory access effects. If a peripheral device is attached to a specific bus or root complex associated with a specific non-uniform memory access node, accessing that device from a processor core on a different node incurs additional latency. The hypervisor 160 attempts to account for these input/output locality constraints when making scheduling decisions.

The computing system 100 depicted in FIG. 1 is designed to support scalable and flexible resource utilization. However, the complexity of the hardware resources 101, particularly the non-uniform memory access characteristics and the shared nature of the interconnects, can create challenges for the scheduler 162. Simple heuristics based solely on processor utilization may fail to capture the nuances of memory locality and interconnect saturation. For instance, a decision to migrate a virtual machine 171 to balance processor load might result in severe memory latency penalties if the data does not follow the computation efficiently. This disconnect between the logical view of resources held by the scheduler 162 and the physical reality of the hardware resources 101 necessitates advanced monitoring and analysis capabilities that leverage the detailed telemetry provided by the performance counters 106 and the performance monitoring unit 163.

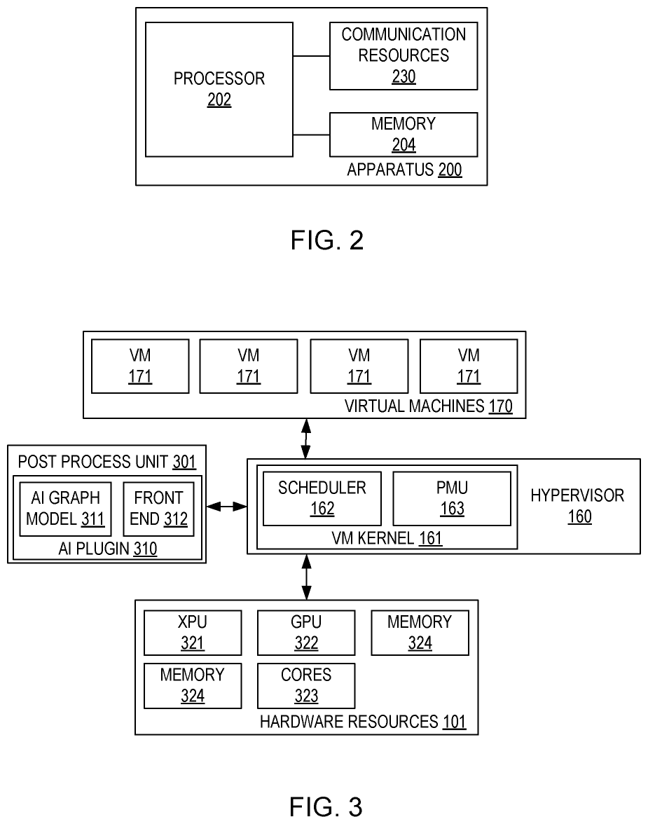

FIG. 2 shows a block diagram of an apparatus in accordance with various aspects described herein. The apparatus 200 is configured to evaluate virtual processing unit to physical processing unit placement quality within a virtualized computing environment, such as the computing system 100 described with reference to FIG. 1. The apparatus 200 includes a processor 202 and a memory 204, and may further include communication resources 230. The processor 202 is operationally coupled to the memory 204 and to the communication resources 230 to facilitate the exchange of data (e.g., data required for placement quality evaluation). The apparatus 200 may act as a post-processing tool, a controller, or a logical entity integrated within the hypervisor 160 or the virtual machine kernel 161. Alternatively, the apparatus 200 may be implemented as a standalone monitoring entity operating in conjunction with the computing system 100. In an example, the logical components of the apparatus 200 may be organized into a front-end unit and an artificial intelligence (AI) unit. The front-end unit may function as a primary interface configured to receive platform and operating system parameters from the virtual machine kernel 161 during system initialization, and the AI unit may use those parameters to construct the graph data structure and perform graph neural network inference as described herein.

The processor 202 serves as the computational core of the apparatus 200. The processor 202 may be implemented as a portion of the processors 102 of the computing system 100, or as a distinct dedicated processing unit configured for hardware telemetry analysis and graph neural network inference, such as a neural network processing unit or a hardware accelerator. The processor 202 executes instructions to construct and maintain the graph data structure stored in the memory 204, to assign edge weights to the edges of the graph data structure based on hardware telemetry data, and to process the graph data structure using the graph neural network to determine a placement quality indicator for a mapping of virtual processing units to physical processing units. The processor 202 interacts with the computing system 100 to discover the system topology by reading system configuration tables, including the Advanced Configuration and Power Interface (ACPI) System Resource Affinity Table (SRAT) and System Locality Information Table (SLIT). The processor 202 may sample hardware telemetry data during workload execution via the performance monitoring unit 163 or the performance counters 106 of the computing system 100.

The memory 204 stores data and instructions accessible to the processor 202. The memory 204 may include a hierarchy of storage technologies comprising volatile random access memory for active data structures and non-volatile storage for persistent model parameters and telemetry logs. The memory 204 may be configured to store the graph data structure comprising nodes of a first type representing physical processing units and nodes of a second type representing virtual processing units within the virtualized computing environment, and edges connecting nodes of the graph data structure, as described with reference to the definitions above. The memory 204 may further store the graph neural network model parameters used by the processor 202 during inference and training, and store the hardware telemetry data sampled from the performance counters 106 and the performance monitoring unit 163 at successive time intervals during workload execution.

The communication resources 230 may be configured to facilitate the exchange of data between the apparatus 200 and the computing system 100. The communication resources 230 may include an input/output interface through which the processor 202 may sample the performance counters 106, read values from the performance monitoring unit 163, and receive scheduler event data from the scheduler 162 of the virtual machine kernel 161. The communication resources 230 further provide the pathway through which the processor 202 can transmit at least one of placement quality results, component attribution data, and migration instructions to the hypervisor 160 or to further physical processing units of the computing system 100. The apparatus 200 may be configured to process the graph data structure as a post-processing operation after completion of at least a portion of the execution of a workload, in which case the communication resources 230 facilitate retrieval of the accumulated telemetry data recorded during that portion of execution.

The memory 204 is configured to store a graph data structure comprising nodes of a first type representing physical processing units (pCPUs) and nodes of a second type representing virtual processing units (vCPUs) within the virtualized computing environment, and edges connecting nodes of the graph data structure. The graph data structure G=(V,E) is defined by a node set V=V_{pCPU}∪V_{vCPU}, where V_{pCPU} contains nodes of the first type and V_{vCPU} contains nodes of the second type, and an edge set E connecting pairs of nodes of the same type. At a high level, the graph data structure simultaneously captures both the physical topology of the hardware resources 101 and the virtual workload structure of the virtual machines 170 as an interconnected network. Each node of the first type may correspond to an individual physical core, a hyper-threaded logical processor, a processor die, or a NUMA node within the hardware resources 101, depending on the granularity of topology representation applied by the processor 202. Each node of the second type corresponds to a virtual processing unit assigned by the hypervisor 160 to a virtual machine 171. In an example, in a computing system 100 comprising two processor sockets with four NUMA nodes and eighty physical cores hosting three virtual machines each configured with forty virtual processing units, the graph data structure may contain eighty nodes of the first type and one hundred and twenty nodes of the second type.

The processor 202 may represent the graph data structure in the memory 204 using an adjacency matrix A, adjacency lists, or edge lists. A weighted adjacency matrix may be used to store the edge weights assigned to the edges, such that each entry of the weight matrix corresponding to a connected pair of nodes holds the scalar edge weight value computed from hardware telemetry data. The graph data structure may be heterogeneous, such that nodes of the first type and nodes of the second type may reside in different feature spaces and may be associated with feature vectors of different dimensionalities, and edges of the first edge type and edges of the second edge type may carry different semantic meanings, as described herein. The processor 202 may obtain the topology of the hardware resources 101 from system configuration tables, including the ACPI System Resource Affinity Table (SRAT) and System Locality Information Table (SLIT), and use this topology information to initialize the node set and edge structure of the graph data structure.

Each node of the first type may be associated with a feature vector derived from hardware performance counter data collected by the performance counters 106 and the performance monitoring unit 163 of the computing system 100. In an example, the feature vector associated with a node of the first type can have a dimensionality of thirty to thirty-five dimensions. The features comprising the feature vector of a node of the first type may include instructions per cycle, L2 cache hit and miss rates, L3 cache hit and miss rates, memory bandwidth utilization, execution unit occupancy, and interconnect traffic metrics between processor sockets. These features may be sampled, by the processor 202, from hardware performance monitoring logs and PMU counter data collected during the execution of the workload. The processor 202 may construct the feature vector for each node of the first type by retrieving hardware counter values from the performance monitoring unit 163 via the communication resources 230 and assembling the sampled values into the feature vector of the corresponding node.

Each node of the second type may be associated with a feature vector derived from scheduler and virtual machine metrics collected by the scheduler 162 and the virtual machine kernel 161 of the hypervisor 160. In an example, the feature vector associated with a node of the second type can have a dimensionality of twenty-five to thirty dimensions. The features comprising the feature vector of a node of the second type may include allotted processing cycles, utilized processing cycles, memory pages allotted, scheduling frequency, migration count, and context switch rate for the corresponding virtual processing unit. These features may be derived from hypervisor scheduler logs and virtual machine performance data. The nodes of the first type and the nodes of the second type are therefore associated with respective feature vectors of different dimensionalities derived from different data sources, namely hardware performance counter data for nodes of the first type, and scheduler and virtual machine metrics for nodes of the second type.

The edges of the graph data structure includes edges of a first edge type connecting pairs of nodes of the first type and edges of a second edge type connecting pairs of nodes of the second type. Edges of the first edge type may represent physical proximity and cache-sharing relationships between pairs of physical processing units within the hardware resources 101. Edges of the second edge type may represent the logical relationship between pairs of virtual processing units belonging to the same virtual machine 171. The graph data structure does not need to include cross-type edges directly connecting nodes of the first type to nodes of the second type. In an example, the mapping of virtual processing units to physical processing units is represented in the placement history that the graph neural network evaluates through the placement quality indicator. The processor 202 establishes the edge structure of the graph data structure based on the hardware topology discovered from the system configuration tables and on the virtual machine assignments reported by the hypervisor 160. During message passing, the processor 202 can use the placement history to identify, for each virtual processing unit node, the physical processing node to which that virtual processing unit is currently mapped, and augment the aggregation for each virtual processing unit node with a message from the embedding of the physical processing unit node. This dynamic cross-type aggregation does not require a stored edge of a third type in the graph data structure, such that the association is read from the placement history data structure at inference time.

The processor 202 may assign edge weights to the edges of the graph data structure based on hardware telemetry data collected during execution of a workload in the virtualized computing environment. The edge weights may represent (e.g., quantify) the dynamic state of the relationship between connected processing units, reflecting runtime hardware conditions. The processor 202 may sample the hardware telemetry data from the performance counters 106 and the performance monitoring unit 163 at defined intervals during workload execution and computes edge weight values from the sampled data. The hardware telemetry data may include, or may be derived from, cache performance counters, execution unit utilization counters, memory bandwidth counters, and interconnect traffic counters associated with the physical processing units. In an example, the processor 202 reads L2 cache miss rates, L3 cache miss rates, and execution unit contention metrics for pairs of physical processing units via the communication resources 230 and computes a composite edge weight for each edge of the first edge type from those values.

Cache performance counters may include hardware registers within the processors 102 including the physical processing units, which count the number of occurrences of specific cache-related events during execution, e.g., accessible via the performance monitoring unit 163. Examples of cache performance counters used in the computation of cache health metrics include: counts of the number of demand requests that were not satisfied by the L2 cache and required servicing from the L3 or memory; counts of last-level cache miss events requiring main memory access; counts L1 of data cache line replacements; and counts of retired load instructions that missed the L3 cache. The cache health metrics A_{L2}(t) and A_{L3}(t) described herein may be each computed as a normalized ratio derived from the corresponding hit and miss counters at the respective cache level: a high ratio of hits to total accesses produces a value of A_{L2}(t) or A_{L3}(t) approaching one, and a high miss rate produces a value approaching zero.

In an example, the edge weights are calculated based on the hardware telemetry data at successive time intervals during the execution of the workload. The processor 202 recalculates the edge weights for all edges at each sampling epoch, replacing the previously stored edge weight values in the memory 204 with values computed from the most recently sampled hardware telemetry data. This recalibration can ensure that the graph data structure stored in the memory 204 reflects the current state of the hardware resources 101 at each epoch, rather than a static snapshot taken at the commencement of workload execution. The duration of the successive time intervals may be configurable based on monitoring overhead constraints and workload characteristics. In an example, the processor 202 recalibrates the edge weights every monitoring epoch using PMU counter readings collected during that epoch, so that the edge weights used during graph neural network inference correspond to the hardware state observed during the most recent interval.

For edges of the first edge type, the edge weights are computed as a product of a static weight component based on a topological distance between the corresponding physical processing units and at least one metric derived from the hardware telemetry data. The static weight component w_{static} for a pair of physical processing units i and j is formulated as: W_{static}(i,j)=w_{L1}·ρ_{L1}(i,j)+w_{L2}·ρ_{L2}(i,j)+w_{L3}·ρ_{L3}(i,j)·f_{dist}(i,j), where ρ_{L1}(i,j), ρ_{L2}(i,j), ρ_{L3}(i,j) are cache-sharing relationship indicators, w_{L1}, w_{L2}, w_{L3} are scalar weights, and f_{dist}(i,j) represents the physical distance between cores i and j. For sibling cores sharing L1 and L2 caches on the same socket, ρ_{L1}=1, ρ_{L2}=1, ρ_{L3}=0. For non-sibling cores on the same socket sharing only the L3 cache, ρ_{L1}=0, ρ_{L2}=0, ρ_{L3}=1. The adaptive edge weight for an edge of the first edge type between physical processing units i and j at time t is then: W_{α}(i,j)=w_{static}·A_{L2}(t)·Aₑₓₑ(i,j,t)·A_{L3}(t), where A_{L2}(t) and A_{L3}(t) are cache health metrics and Aₑₓₑ(i,j,t) is a resource contention metric, each described further below.

For example: wherein the edge weights for edges of the first edge type are computed as: W_{α}(i,j)=w_{static}(i,j)·A_{L2}(t)·Aₑₓₑ(i,j,t)·A_{L3}(t), wherein w_{static}(i,j) is the static weight component, A_{L2}(t) is an L2 cache health factor derived from L2 cache hit and miss rates at time t, Aₑₓₑ(i,j,t) is an execution resource contention factor indicating pipeline contention between physical processing units i and j at time t, and A_{L3}(t) is an L3 cache health factor derived from last-level cache hit and miss rates at time t, wherein each of A_{L2}(t), Aₑₓₑ(i,j,t), ∧ A_{L3}(t) is computed independently from the hardware telemetry data such that degradation of any single hardware health dimension reduces the edge weight independently of the other.

The topological distance between two physical processing units may be a scalar measure of the number of hardware hierarchy boundaries that must be crossed to communicate between those units. The topological distance is not a physical spatial measure but a representation of the cache and interconnect hierarchy of the hardware resources 101. The processor 202 may derive topological distance values from the platform firmware tables, including the ACPI System Locality Information Table, which records the relative distance between NUMA nodes as normalized integer values, and from the processor topology exposed via CPUID leaves and system resource affinity tables. In an example, two hyper-threaded logical processors sharing the same physical core may have a topological distance of zero, as they share the L1 instruction cache, L1 data cache, L2 cache, and all execution resources. Two cores residing on the same die and sharing an L3 cache segment may have a greater topological distance, reflecting one additional cache boundary. Two cores residing on different dies within the same processor package under sub-NUMA clustering may have a greater topological distance reflecting the internal mesh interconnect crossing. Two cores residing on different physical sockets, each attached to a distinct memory controller, may have the greatest topological distance within a two-socket platform. In platforms with more than two sockets, the topological distance between cores on non-adjacent sockets may be greater.

The at least one metric derived from the hardware telemetry data comprises a cache health metric determined from cache performance counters associated with the corresponding physical processing units. The cache health metric comprises separate metrics corresponding to respective cache levels of the physical processing units: A_{L2}(t) represents L2 cache health at time t, and A_{L3}(t) represents L3 cache health at time t. Each cache health metric is computed from the cache hit and miss rates at the respective cache level, sampled from the performance monitoring unit 163, and takes a scalar value in a normalized range where a lower value indicates degraded cache performance at the corresponding level. In an example, a low A_{L2}(t) value for a pair of physical processing units indicates elevated L2 miss rates for those units at time t, which reduces the edge weight W_{α}(i,j) for the corresponding edge of the first edge type, indicating that the relationship between those physical processing units is subject to L2 cache pressure at the current epoch.

The at least one metric further comprises a resource contention metric Aₑₓₑ(i,j,t) indicating a degree of contention for execution resources between the corresponding physical processing units. Aₑₓₑ(i,j,t) captures CPU pipeline contention specific to hyper-threading: when two logical processors sharing a single physical core compete for execution units, the degree of contention for shared pipeline resources increases. Aₑₓₑ(i,j,t) is a scalar value such that high contention between physical processing units i and j at time t produces a low Aₑₓₑ(i,j,t), which in turn reduces the edge weight W_{α}(i,j). The graph neural network, through training, learns to identify placement configurations in which competing virtual processing units are assigned to physical processing units exhibiting high execution resource contention, because the correspondingly low edge weights for such pairs indicate unfavorable hardware conditions for co-placement.

Contention for execution resources refers to competition between two or more logical processors sharing the physical execution pipeline of a single core for access to resources with limited capacity, including integer arithmetic logic units, floating-point units, load and store units, the reorder buffer, and instruction fetch bandwidth. Contention arises specifically in hyper-threaded configurations where two logical processors, each constituting a distinct physical processing unit, share these resources simultaneously. The resource contention metric Aₑₓₑ(i,j,t) described herein indicates the degree to which such competition is occurring between physical processing units i and j at time t. Examples of hardware performance counters from which Aₑₓₑ(i,j,t) may be derived include counts of cycles stalled due to store buffer full conditions attributable to simultaneous thread activity, counts of reorder buffer full stalls, and counts of cycles in which the sibling hyper-thread is active while the current thread is stalled.

For edges of the second edge type, the edge weights are based on a ratio of a shared memory quantity between the corresponding virtual processing units to a distance between the physical processing units to which those virtual processing units are mapped. The edge weight W_{vcpu}(i,j,t) for an edge of the second edge type between virtual processing units i and j at time t is formulated as: W_{vcpu}(i,j,t)=memor y_{shared}/current_pcpu_distance, where memor y_{shared} is the quantity of memory pages shared between virtual processing units i and j, and current_pcpu_distance is the topological distance between the physical processing units to which virtual processing units i and j are currently mapped. For virtual processing units belonging to different virtual machines, the edge weight is zero: W_{vcpu}(i,j,t)=0, because edges of the second edge type connect only virtual processing units belonging to the same virtual machine, given that virtual machines are isolated from one another. In an example, two virtual processing units of the same virtual machine sharing a large quantity of memory pages but mapped to physical processing units on different sockets produce a high numerator relative to a high denominator, yielding an edge weight that indicates placement tension between memory sharing requirements and physical separation.

The shared memory quantity between two virtual processing units i and j refers to the number of memory pages that both virtual processing units access within a measurement epoch, as recorded by the hypervisor memory management subsystem or by memory access tracking facilities of the hardware resources 101. A memory page may be considered shared between virtual processing unit i and virtual processing unit j if both units perform read or write operations to addresses within that page during the epoch. In an example, two virtual processing units of the same virtual machine that operate jointly on a shared in-memory database buffer pool access a large number of common pages within each epoch, yielding a high memor y_{shared} value and consequently a high edge weight W_{vcpu}(i,j,t) for the edge of the second edge type connecting them, indicating that their placement on topologically proximate physical processing units is desirable. Conversely, two virtual processing units that operate on entirely independent data streams with no overlapping page accesses yield a memor y_{shared} value of zero, producing an edge weight of zero and indicating that their co-location is irrelevant to placement quality. For virtual processing units belonging to different virtual machines, the edge weight is zero regardless of memory access patterns, because the second edge type connects only virtual processing units within the same virtual machine, as described herein.

The distance between physical processing units in the denominator of the edge weight formula W_{vcpu}(i,j,t)=memor y_{shared}/current_pcpu_distance refers to the topological distance described herein between the physical processing unit to which virtual processing unit i is currently mapped and the physical processing unit to which virtual processing unit j is currently mapped. The processor 202 may derive this value from the ACPI SLIT table or equivalent platform topology data at each recalibration epoch. In an example, if virtual processing unit i is mapped to a physical processing unit on Socket 0 and virtual processing unit j is mapped to a physical processing unit on Socket 1 in a dual-socket platform, current_pcpu_distance takes the cross-socket SLIT distance value of twenty-one; if both virtual processing units are mapped to physical processing units within the same NUMA node, current_pcpu_distance takes the local distance value of ten. A large memor y_{shared} value combined with a large current_pcpu_distance produces a moderate edge weight, indicating that the virtual processing units share significant data but are placed far apart; a large memor y_{shared} value combined with a small current_pcpu_distance produces a high edge weight, indicating a favorable placement in which data-sharing virtual processing units are topologically proximate.

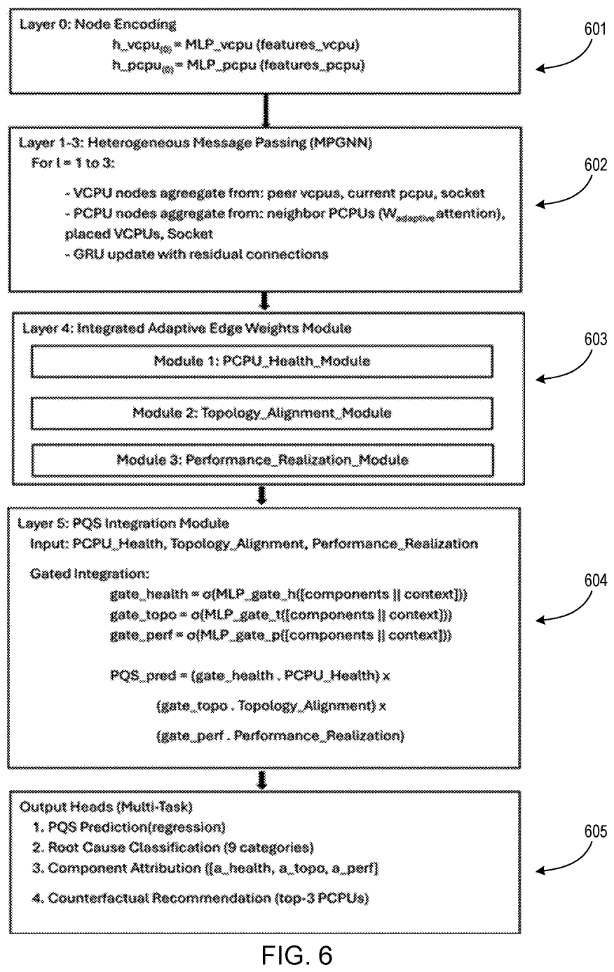

The processor 202 is configured to process the graph data structure comprising the edge weights using a graph neural network to determine a placement quality indicator for a mapping of at least one virtual processing unit of the virtual processing units to at least one physical processing unit of the physical processing units. The graph neural network receives the heterogeneous graph data structure with adaptive edge weights and produces a quantitative assessment of how well the current vCPU-to-pCPU mapping serves the workload given the observed hardware state. The placement quality indicator may be a composite score in the range [0, 1], where a higher value indicates a placement mapping of greater quality. The graph neural network comprises multiple sequential layers including a node encoding layer, a plurality of message passing layers, at least one differentiable neural layer configured to compute placement quality components from the node embeddings and the edge weights, and an integration layer that combines those components into the placement quality indicator. The detailed architecture of the graph neural network is described further below with reference to FIG. 6.

The graph neural network utilizes a message-passing mechanism in which nodes update their representations by aggregating information from neighboring nodes, with the edge weights modulating the strength of that aggregation. For a virtual processing unit node i, the message passing layer aggregates information from peer virtual processing unit nodes belonging to the same virtual machine and from the physical processing unit node to which virtual processing unit i is currently mapped, producing Messages(vcpu)=Concat(vcpu-vcpu aggregation, vcpu-pcpu aggregation). For a physical processing unit node j, the message passing layer aggregates information from neighboring physical processing unit nodes using the adaptive edge weights W_{α} as attention sources, and additionally aggregates information from virtual processing unit nodes currently mapped to physical processing unit j, producing Messages(pcpu)=Concat(pcpu aggregation, vcpu aggregation). The adaptive edge weights directly modulate the strength of information flow between physical processing unit nodes during aggregation, so that physical processing unit pairs with high cache health and low execution resource contention contribute more strongly to each other's updated representations.

In operation, the processor 202 may construct the graph data structure by mapping the hardware topology of the computing system 100 to nodes of the first type and mapping the virtual processing unit assignments reported by the hypervisor 160 to nodes of the second type and to the edges of the graph data structure. The processor 202 may then compute edge weights from hardware telemetry data collected during workload execution, recalibrating those edge weights at each successive time interval. The processor 202 may then feed the graph data structure comprising the updated edge weights and the assembled node feature vectors into the graph neural network, which processes the heterogeneous node representations through the message passing layers, computes placement quality components via differentiable neural layers, and integrates those components using a gated integration to produce the placement quality indicator. Where the placement quality indicator falls below a threshold, the processor 202 may generate a root cause classification, a component attribution, or a recommendation of at least one alternative physical processing unit for the mapping. In various aspects described herein, the gated integration may involve sigmoid-activated gate values that are computed from a context vector derived from the placement quality components, and the placement quality indicator may be determined as a product of each gate value with its corresponding placement quality component.

The apparatus 200 can evaluate whether the current assignment of each virtual processing unit to its respective physical processing unit is efficient given the current state of the hardware resources 101. The apparatus 200 may accomplish this by: (a) representing the physical and virtual topologies of the hardware resources 101 and the virtual machines 170 as a heterogeneous graph data structure comprising nodes and edges stored in the memory 204 (b) quantifying the current hardware state as adaptive edge weights derived from hardware telemetry data sampled from the performance counters 106 and the performance monitoring unit 163 at successive time intervals; and (c) processing the graph data structure through the graph neural network, which has learned through training to distinguish between placements of differing quality and to produce, from a single forward pass, a placement quality indicator together with associated diagnostic and recommendation outputs.

FIG. 3 illustrates the system integration of a post processing unit within the virtualized computing environment described with reference to FIG. 1. The post processing unit 301 may correspond to the apparatus 200 described with reference to FIG. 2 and implement the placement quality evaluation aspects described herein. The post processing unit 301 can include an AI plugin 310, which in turn comprises an AI graph model 311 and a front end 312. The AI graph model 311 is implemented by the processor 202 and the memory 204 of the apparatus 200 and carries out graph construction, adaptive edge weight computation, and graph neural network inference as described herein. The front end 312 corresponds to the front-end unit of the apparatus 200 and uses the communication resources 230 to interface bidirectionally with the virtual machine kernel 161 of the hypervisor 160. The hypervisor 160 manages the virtual machines 170, each comprising a virtual machine 171, executing above the virtual machine kernel 161. The virtual machine kernel 161 includes the scheduler 162 and the performance monitoring unit 163 described with reference to FIG. 1. The hardware resources 101 situated below the hypervisor 160 include physical processing cores 323, XPUs 321, GPUs 322, and memory devices 324, which correspond to the hardware resources 101 described with reference to FIG. 1. Upon system initialization, the front end 312 captures platform topology and operating system parameters from the virtual machine kernel 161 and supplies that information to the AI graph model 311 to enable construction of the graph data structure and initialization of node and edge structures.

In an example, the processor 202 of the post processing unit 301 is configured to process the graph data structure as a post-processing operation after completion of at least a portion of the execution of a workload in the virtualized computing environment. In the proposed workflow, the AI plugin 310 performs post-processing of the entire workload execution by utilizing metrics obtained through the graph techniques described herein. The AI graph model 311 employs graph composition techniques together with a topology-based factorized adaptive edge weight pipeline to systematically analyze the accumulated telemetry data and assess the placement of each virtual processing unit on a physical processing unit. The front end 312 functions as the primary interface, capturing platform and operating system parameters via the virtual machine kernel 161, and supplying those parameters to the AI graph model 311 for topology analysis and graph construction. The graph neural network modules of the AI graph model 311 are trained to determine the placement quality indicator for each virtual processing unit to physical processing unit mapping recorded during workload execution, thereby identifying placements that were suboptimal and quantifying the nature and severity of each deficiency. Post-processing allows the complete execution trace of the workload to be available to the processor 202 during analysis, enabling evaluation of temporal degradation patterns and the full migration history of each virtual processing unit.

In an example, the processor 202 is further configured to send an instruction to at least one of the hypervisor 160 or a further physical processing unit of the physical processing units to cause at least one virtual processing unit to be migrated from the at least one physical processing unit to the further physical processing unit based on the placement quality indicator. When the placement quality indicator for a given virtual processing unit to physical processing unit mapping falls below a threshold, and the graph neural network produces a counterfactual recommendation identifying one or more alternative physical processing units as described herein, the processor 202 generates a migration instruction identifying the target physical processing unit. The processor 202 transmits this instruction via the communication resources 230 to the scheduler 162 of the virtual machine kernel 161, as illustrated by the bidirectional communication path between the post processing unit 301 and the virtual machine kernel 161 in FIG. 3. In an example, applying placement quality indicator-guided migration instructions reduced erroneous virtual processing unit migrations from approximately 18,000 to approximately 15,000 migration events, representing an approximate 20% reduction, and produced a benchmark score improvement of 8% to 12%.

Upon receiving the migration instruction, the scheduler 162 of the virtual machine kernel 161 may initiate a live migration of the identified virtual processing unit from the source physical processing unit to the target physical processing unit recommended by the graph neural network. Live migration preserves the execution state of the virtual processing unit, transferring processor context and any associated memory pages to the target physical processing unit while the workload continues execution, in a manner consistent with the hypervisor migration mechanisms. The migration instruction generated by the processor 202 may specify one or more candidate target physical processing units ranked by the placement quality indicator predicted for each candidate, enabling the scheduler 162 to select among them based on current load conditions at the time of migration. Following completion of the migration, the processor 202 may update the graph data structure in the memory 204 to reflect the new virtual processing unit to physical processing unit mapping and may re-evaluate the placement quality indicator for the affected virtual processing unit against the post-migration hardware telemetry data to verify that the placement quality indicator has transitioned above the threshold. Where the post-migration placement quality indicator remains below the threshold, the processor 202 may generate a further migration instruction to an alternative physical processing unit, or may generate a root cause classification and component attribution output for review by a platform administrator, as described herein.

In an example, the root cause classification output of the graph neural network may indicate the category of placement deficiency for a given virtual processing unit to physical processing unit mapping as one of multiple (e.g., nine) classification categories. A classification of L3 cache degradation may be produced when the A_{L3}(t) adaptive factor may be the dominant contributor to the reduced edge weights at the assigned physical processing unit at the time of evaluation, indicating that the L3 cache shared by that physical processing unit is experiencing a high miss rate attributable to co-tenancy with competing workloads. A classification of L2 contention may be produced when the A_{L2}(t) factor is depressed while A_{L3}(t) remains healthy, indicating that the placement deficiency originates at the L2 cache level rather than the last-level cache. A classification of topology misalignment may be produced when the topology alignment component is the dominant factor in the reduced placement quality indicator, indicating that virtual processing units of the same virtual machine with high shared memory edge weights are mapped to physical processing units on different sockets, incurring cross-socket memory access penalties. A classification of workload mismatch may be produced when the performance realization component is low despite healthy cache and contention metrics, indicating that the characteristics of the workload executing on the virtual processing unit are poorly matched to the execution resources of the assigned physical processing unit. A classification of good placement may be produced when the placement quality indicator is above the threshold and all three component scores are within acceptable ranges.

In an example, a virtual processing unit evaluated at a particular epoch can yield a placement quality indicator of 0.35. The component attribution output [a_health, a_topo, a_perf] for that mapping may be, for example, [0.70, 0.20, 0.10], indicating that seventy percent of the placement quality deficit is attributable to degraded physical processing unit health, that is specifically elevated L3 miss rates and execution resource contention at the assigned physical processing unit, twenty percent to suboptimal topology alignment of the virtual processing units of the same virtual machine, and ten percent to performance realization. This attribution may direct remediation toward the pCPU health dimension: reassigning the virtual processing unit to a physical processing unit with a lower co-tenancy load and healthy L3 cache is expected to produce a greater improvement in the placement quality indicator than adjusting the VM-level topology alignment alone.

In an example, the counterfactual recommendation output for a virtual processing unit currently mapped to a physical processing unit on Socket 1 exhibiting high L3 co-tenancy may produce a ranked list, for example a ranked list of three alternative physical processing units: first, a physical processing unit on Socket 0, NUMA node 0, with a predicted placement quality indicator of 0.89, identified as the top candidate on the basis of low L3 co-tenancy, a current load below fifty percent, and topological proximity to the physical processing units hosting the peer virtual processing units of the same virtual machine; second, a physical processing unit on Socket 0, NUMA node 0, with a predicted placement quality indicator of 0.85, adjacent to the first candidate but with marginally higher current load; and third, a physical processing unit on Socket 0, NUMA node 1, with a predicted placement quality indicator of 0.78, topologically proximate within the same socket but in a different sub-NUMA cluster. The processor 202 may use the top-ranked candidate physical processing unit as the target in a migration instruction transmitted to the hypervisor 160, as described herein.

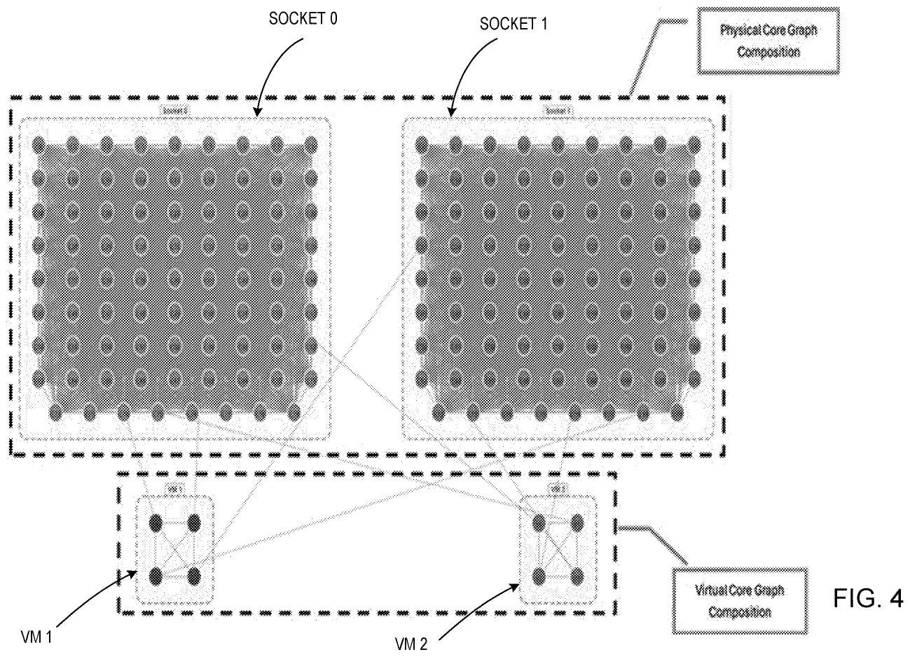

In an example, the graph data structure comprises a first graph composition comprising the nodes of the first type and a second graph composition comprising the nodes of the second type. FIG. 4 illustrates an example of the two graph compositions of the graph data structure stored in the memory 204. The first graph composition, labeled the physical core graph composition, occupies the upper portion of FIG. 4 and models the physical processing unit topology of the hardware resources 101. The second graph composition, labeled the virtual core graph composition, occupies the lower portion of FIG. 4 and models the virtual processing unit structure of the virtual machines 170 executing in the virtualized computing environment. The physical core graph composition is created specifically for physical cores and the virtual core graph composition is created specifically for virtual cores. This organizational separation preserves the semantic distinction between the physical hardware topology and the virtual workload structure within a single graph data structure, enabling the graph neural network to process both compositions and to evaluate the quality of the mapping between them. The connecting lines visible in FIG. 4 between the physical core graph composition and the virtual core graph composition represent the vCPU-to-pCPU placement mapping that the graph neural network evaluates through the placement quality indicator.

In an example, the first graph composition comprises a plurality of subgraphs, each subgraph of the first graph composition corresponding to a respective memory access domain of the virtualized computing environment. The number of subgraphs in the first graph composition may equal the number of NUMA nodes or dies in the hardware resources 101. The physical core graph composition may contain two subgraphs, namely a first subgraph corresponding to Socket 0, whose nodes are shown on the left hand side, and a second subgraph corresponding to Socket 1, whose nodes are shown on the right hand side. Each subgraph of the first graph composition may contain nodes of the first type representing the physical processing units belonging to the corresponding memory access domain, with edges of the first edge type connecting pairs of those nodes to represent cache-sharing and proximity relationships within that domain. Edges connecting nodes across the two subgraphs may represent the inter-socket relationships between physical processing units belonging to different memory access domains. In an example, a dual-socket platform employing sub-NUMA clustering that produces four NUMA nodes results in four subgraphs in the first graph composition, one per NUMA node or die.

In an example, the second graph composition comprises a plurality of subgraphs, each subgraph of the second graph composition corresponding to a respective virtual machine executing in the virtualized computing environment. The number of subgraphs in the second graph composition may equal the number of virtual machines executing the workload. The virtual core graph composition may contain two subgraphs, namely a first subgraph labeled VM 1, containing nodes on the left hand side, and a second subgraph labeled VM 2, containing nodes on the right hand side. Each subgraph of the second graph composition may contain nodes of the second type representing the virtual processing units allocated to the corresponding virtual machine, with edges of the second edge type connecting those nodes. In the virtual core graph composition, one node of the second type is created per virtual core, and virtual machine and scheduler metrics are used for node embedding of each virtual processing unit node. In an example, a workload executing across a number N of (e.g., three) virtual machines each configured with a distinct set of virtual processing units results in N (e.g., three) subgraphs in the second graph composition, one per virtual machine.

In an example, edges within the second graph composition connect nodes of the second type that belong to a same virtual machine. As illustrated in FIG. 4, the nodes within the VM 1 subgraph are connected to one another by edges of the second edge type, forming a fully connected subgraph, and the nodes within the VM 2 subgraph are likewise connected to one another, but no edges of the second edge type cross between the VM 1 subgraph and the VM 2 subgraph. Edges between two virtual processing unit nodes may be established only when those nodes belong to the same virtual machine. In other terms, they may be configured such that there are no cross-virtual-machine edges, because virtual machines are isolated from one another and do not share memory or scheduling context during normal operation. This constraint means that the edge weight W_{vcpu}(i,j,t) may be computed only for virtual processing unit pairs within the same virtual machine, and that the graph neural network learns to evaluate placement quality within the context of each virtual machine's virtual processing unit group independently of other virtual machines executing concurrently in the virtualized computing environment.

In the physical core graph composition, the nodes of the first type represent physical processing units may be organized into subgraphs corresponding to respective memory access domains, with edges of the first edge type reflecting the cache-sharing and topological proximity relationships between physical processing units within and across those subgraphs. In the virtual core graph composition, the nodes of the second type may represent virtual processing units of the respective virtual machines 171, with edges of the second edge type connecting nodes belonging to the same virtual machine, as described herein.

Correspondingly, with reference to FIG. 4, in the physical core graph composition, one node of the first type may be created per physical core of the hardware resources 101. The feature vector associated with each such node can be derived from hardware performance counter data, including metrics collected from the performance counters 106 and the performance monitoring unit 163, such as hardware performance monitoring data from EMON logs. In an example, the hardware performance counter data used for feature vector construction of physical processing unit nodes includes instructions per cycle, L2 and L3 cache miss rates, memory bandwidth utilization, and execution unit occupancy.

In the virtual core graph composition, one node of the second type may be created per virtual core of the respective virtual machine 171. The feature vector associated with each such node can be derived from scheduler and virtual machine metrics provided by the scheduler 162 and the virtual machine kernel 161. In an example, those metrics include allotted and utilized processing cycles, memory pages allotted, scheduling frequency, and context switch rate, derived from hypervisor scheduler logs. The feature vectors of nodes of the first type and nodes of the second type may be derived from different data sources, such as hardware performance counter data and scheduler and virtual machine metrics respectively, and have different dimensionalities.

The graph data structure may further employs factorized adaptive weights for two distinct edge types considered in the adaptive edge weight composition. The first edge type may only include edges between physical processing units, corresponding to the edges connecting pairs of nodes of the first type within and between the subgraphs of the physical core graph composition. The second edge type may only include edges between virtual processing units, corresponding to the edges connecting pairs of nodes of the second type within the subgraphs of the virtual core graph composition. The processor 202 may assign edge weights to edges of the first edge type using the adaptive edge weight formula Wₐₗₚₕₐ(i,j) as described herein, incorporating the static weight component and the hardware telemetry-derived factors A_L2(t), Aₑₓₑ(i,j,t), and A_{L3}(t). The processor 202 may assign edge weights to edges of the second edge type using the shared memory to physical processing unit distance ratio W_{vcpu}(i,j,t) as described, with the edge weight set to zero for virtual processing units belonging to different virtual machines.

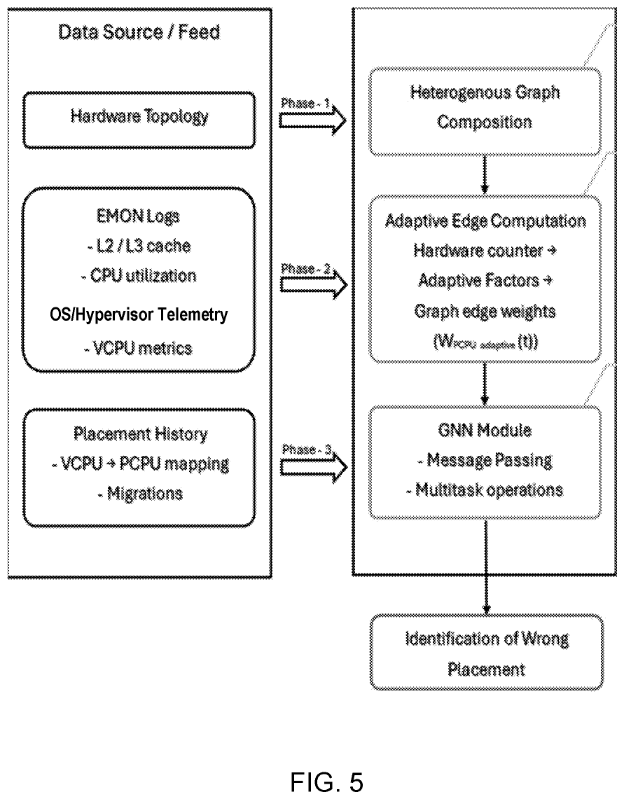

FIG. 5 illustrates an example three-phase architecture pipeline of the apparatus 200. The pipeline is organized as two columns: a data source and feed column on the left and a processing pipeline column on the right. The data source and feed column indicates three possible categories of input corresponding to the three phases: hardware topology data feeding Phase 1, hardware telemetry data that may include EMON logs and hypervisor/OS telemetry (e.g., resource utilization logs) feeding Phase 2, and placement history data comprising vCPU-to-pCPU mapping records and migration records feeding Phase 3. The three processing phases in the right column may produce the heterogeneous graph composition, the adaptive edge weights, and the graph neural network module outputs sequentially, as described herein, with the final output of the pipeline being the identification of wrong or suboptimal placement.

In Phase 1, the processor 202 may receive hardware topology information from the platform via system configuration tables, which may include the ACPI SRAT and SLIT tables. The processor 202 may construct the heterogeneous graph composition as described herein. The processor 202 may map the physical processing units discovered from the hardware topology to nodes of the first type in the graph data structure, establishing the physical core graph composition with its subgraphs corresponding to respective memory access domains. The processor 202 may also map the virtual processing units of the executing virtual machines 171 to nodes of the second type, establishing the virtual core graph composition with its subgraphs corresponding to respective virtual machines.

In Phase 2, the processor 202 receives hardware telemetry data that may include EMON logs including L2/L3 cache data and CPU utilization metrics, and hypervisor/OS telemetry (e.g., resource utilization logs) including virtual processing unit metrics. The processor 202 may perform adaptive edge computation. The adaptive edge computation can proceed as a three-step pipeline as depicted herein. The processor 202 samples hardware counter values from the performance counters 106 and the performance monitoring unit 163. The processor 202 uses those counter values to derive the adaptive factors, such as A_{L2}(t), Aₑₓₑ(i,j,t), and A_{L3}(t). The processor 202 combines those adaptive factors with the static weight component w_{static} to produce the graph edge weights W_PCPU_adaptive(t) for edges of the first edge type, corresponding to the adaptive edge weight formula as described herein. For edges of the second edge type, the processor 202 uses the virtual processing unit metrics from the hypervisor/OS telemetry (e.g., resource utilization logs) to compute the shared memory to physical processing unit distance ratio. The processor 202 may recalculate both sets of edge weights at each successive time interval during workload execution.

In Phase 3, the processor 202 receives placement history data comprising recorded vCPU-to-pCPU mapping assignments and migration events for the workload. The processor 202 feeds the graph data structure comprising the adaptive edge weights produced in Phase 2 and the node feature vectors constructed in Phase 1, together with the placement history, into the graph neural network module. The graph neural network module may perform message passing operations and multi-task operations on the graph data structure to produce the placement quality indicator for each vCPU-to-pCPU mapping, as described herein. The three-phase pipeline of described herein may be executed as a post-processing operation after completion of at least a portion of workload execution, in which case all three phases operate on the complete hardware topology, accumulated telemetry data, and full placement history recorded during that portion of execution.

The output of the three-phase pipeline may include the identification of wrong or suboptimal placement, represented by the output block at the base of the processing pipeline column. Where the placement quality indicator produced by the graph neural network module in Phase 3 is below a threshold, the processor 202 identifies the corresponding vCPU-to-pCPU mapping as a suboptimal placement. Based on that identification, the processor 202 may generate a root cause classification indicating the category of placement deficiency, a component attribution quantifying the contribution of each placement quality component, and a recommendation of at least one alternative physical processing unit, as described herein. The processor 202 may further send a migration instruction to the hypervisor 160 based on the placement quality indicator, as described herein.

FIG. 6 depicts an exemplary illustration of a graph neural network in accordance with various aspects described herein. The graph neural network comprises a plurality of layers 601 to 605. A graph neural network described herein may include at least one or a combination of (e.g., all of) the layers described herein. These layers are presented as five sequential layer blocks 601 through 604 followed by a multi-task output block 605. The sequential arrangement proceeds from the node encoding layer 601 through the heterogeneous message passing module 602, the Integrated Adaptive Edge Weights Module 603, and the PQS Integration Module 604, to the output heads block 605. The node encoding layer 601 and the message passing module 602 can together constitute the representation learning portion of the architecture, and the Integrated Adaptive Edge Weights Module 603 and the PQS Integration Module 604 can together constitute the placement quality computation portion.

The layers may include a message passing layer 602. The message passing layer 602 may be configured to aggregate information from neighboring nodes through heterogeneous message passing (MPGNN), applied for layers l=1 to 3. For each virtual processing unit node i, the message passing layer 602 may perform one or two of aggregation operations.

For example, the message passing layer 602 may perform a first aggregation collecting messages from peer virtual processing unit nodes belonging to the same virtual machine. The message passing layer 602 may perform a second aggregation collecting messages from the physical processing unit node to which virtual processing unit i is currently mapped, yielding Messages(vcpu)=Concat(vcpu-vcpu aggregation, vcpu-pcpu aggregation) (Concat being an aggregation operator to concatenate). For each physical processing unit node j, the message passing layer 602 may perform a first aggregation collecting messages from neighboring physical processing unit nodes using the adaptive edge weights W_{adaptive} directly as attention sources, and a second aggregation collecting messages from virtual processing unit nodes currently mapped to physical processing unit j, yielding Messages(pcpu)=Concat(pcpu aggregation, vcpu aggregation). The adaptive edge weights directly modulate the aggregation between nodes of the first type: a higher adaptive edge weight between two physical processing unit nodes produces stronger information flow between those nodes during the aggregation step, so that the message passing layers 602 propagate the current hardware state encoded in those weights across the physical topology.

The graph neural network comprises a node encoding layer 601, that precedes the message passing layers 602. The node encoding layer transforms the raw input features of each node into an embedding space (e.g., a unified 128-dimensional embedding space). Layer 0 performs node encoding separately for virtual processing unit nodes and physical processing unit nodes. For virtual processing unit nodes, a multi-dimensional (e.g., the twenty-five to thirty dimension) input feature vector may be passed through a multilayer perceptron (MLP), producing the initial embedding h_vcpu_(0)=MLP_vcpu(features_vcpu). For physical processing unit nodes, another multi-dimensional (e.g., the thirty to thirty-five dimension) input feature vector is passed through a separate MLP, producing h_pcpu_(0)=MLP_pcpu(features_pcpu). Both MLPs may share the same architecture: Linear(input_dim→256)→ReLU→Dropout(0.1)→Linear(256→128)→LayerNorm(128). LayerNorm stabilizes training by normalizing activations, and dropout prevents overfitting. The node encoding layer 601 projects the heterogeneous input features of both node types, which can differ in dimensionality and data source, into a common 128-dimensional embedding space before the message passing layers 602 operate on them.

In an example, each message passing layer of the message passing layers 602 applies a Gated Recurrent Unit (GRU) update with residual connections after aggregating the concatenated messages for each node. The GRU update gate selectively incorporates the aggregated messages with the node representation from the previous layer, computing a new node representation that balances new neighborhood information against the representation already accumulated. The residual connection can add the previous layer's representation directly to the updated representation, enabling the network to preserve feature information from earlier layers and mitigating over-smoothing of node representations that can occur across multiple message passing layers. The GRU update may be applied for both virtual processing unit nodes and physical processing unit nodes at each of the three message passing layers l=1 to 3.

The graph neural network comprises at least one differentiable neural layer configured to compute a placement quality metric from embeddings of the nodes and the edge weights. The parameters of the at least one differentiable neural layer may be jointly trained with the parameters of the graph neural network. This differentiable neural layer may include Layer 4, the Integrated Adaptive Edge Weights Module 603. The Integrated Adaptive Edge Weights Module 603 may be configured to compute placement quality components using the GNN node embeddings produced by the message passing layers 602 together with the analytical formulas for placement quality. The adaptive weight formulas are not external features applied to the graph data structure but may be implemented as learnable modules within the Integrated Adaptive Edge Weights Module 603, enabling the placement quality computations to be jointly optimized with the message passing parameters during end-to-end training. The Integrated Adaptive Edge Weights Module 603 may include three sub-modules: Module 1 (PCPU_Health_Module), Module 2 (Topology_Alignment_Module), and Module 3 (Performance_Realization_Module), each producing a distinct placement quality component score.

In an example, the at least one differentiable neural layer described herein comprises a performance differentiable neural layer configured to compute a performance metric based on a ratio of an estimated actual performance metric to an estimated expected performance metric for the mapping. Module 1, the PCPU_Health_Module, may be a suitability differentiable neural layer configured to compute a suitability metric for a physical processing unit, which the computing may be based on the edge weights and the current load of the physical processing unit. The suitability metric for physical processing unit j at time t is:

PCPU_{Suitability}(j,t)=Wₐₗₚₕₐ(j,t)×(1−[CurrentLoad(j,t)/100])

where Wₐₗₚₕₐ(j,t) may be the adaptive edge weight incorporating L3 cache health, L2 cache health, and execution contention for physical processing unit j, and CurrentLoad(j,t) is the current processor utilization expressed as a percentage. The Module 1 implementation may proceed in three steps. In Step 1, the adaptive factors are contextualized, such that for memory-streaming workloads, the L3 cache health factor may learn to contribute less to the suitability score because such workloads are less sensitive to L3 co-tenancy. In Step 2, the contextualized factors may be combined using a learnable combination rather than a fixed multiplication. In Step 3, the output may be normalized to [0, 1]. In an example, a physical processing unit with healthy caches but a current load of ninety-five percent yields a low suitability score, indicating unsuitability for hosting an additional virtual processing unit despite favorable cache conditions.

In an example, the at least one differentiable neural layer described herein comprises a performance differentiable neural layer configured to compute a performance metric based on a ratio of an estimated actual performance metric to an estimated expected performance metric for the mapping. Module 2, the Topology_Alignment_Module, may be a topology alignment differentiable neural layer configured to compute an alignment metric indicating the degree to which virtual processing units of a same virtual machine are mapped to topologically proximate physical processing units. The topology alignment metric may be formulated as:

Topology_{Alignment}(i,j,t)=Σ[w_{vcpu}(i,k)×w_pcpu_adaptive(j,k)]/Normalized_Weight

where w_{vcpu}(i,k) is the edge weight between virtual processing unit i and peer virtual processing unit k of the same virtual machine, w_pcpu_adaptive(j,k) is the adaptive edge weight between physical processing unit j and the physical processing unit to which peer virtual processing unit k is currently mapped, and Normalized_Weight normalizes the sum to the maximum possible weight. The Module 2 implementation may proceed in four steps: Step 1 may compute peer importance for every virtual processing unit in the same virtual machine; Step 2 may compute contextualized edge quality for each physical processing unit pair; Step 3 may perform weighted aggregation over all peer contributions; Step 4 may normalize the result. In an example, two tightly coupled virtual processing units of the same virtual machine placed on physical processing units within the same NUMA node produce a high topology alignment score, whereas placement on physical processing units on different sockets produces a low score.

In an example, the at least one differentiable neural layer described herein comprises a performance differentiable neural layer configured to compute a performance metric based on a ratio of an estimated actual performance metric to an estimated expected performance metric for the mapping. Module 3, the Performance_Realization_Module, may be a performance differentiable neural layer configured to compute a performance metric based on a ratio of an estimated actual performance metric to an estimated expected performance metric for the mapping. The performance realization metric is:

Performance_{Realization}(i,j,t)=Actual_Performance/Expected_Performance

The Module 3 implementation may proceed in four steps: Step 1 may compute a workload-to-physical-processing-unit match score from the node embeddings; Step 2 may predict the expected and reasonable performance for the virtual processing unit given its workload characteristics and the target physical processing unit; Step 3 may predict the actual instructions per cycle (IPC) achieved by the virtual processing unit on the current physical processing unit; Step 4 may compute the performance realization ratio. In an example, if the predicted expected IPC for a virtual processing unit is 2.0 and the estimated actual IPC is 1.2, the performance realization metric is 0.6, indicating that the virtual processing unit achieves sixty percent of the performance it should realize given its placement.

The processor 202 may further be configured to combine the outputs of the three differentiable neural layer sub-modules using a gated integration comprising learned gate values that determine the relative contribution of each placement quality component to the placement quality indicator. This may correspond to Layer 5, the PQS Integration Module 604, shown in FIG. 6. The PQS Integration Module 604 may combine the three component scores from the Integrated Adaptive Edge Weights Module 603 into an overall placement quality indicator using gated integration. The gated integration may proceed in four steps. In Step 1, a context vector may be constructed from the three component scores. In Step 2, three gate values may be computed using learned multilayer perceptrons with sigmoid activation:

gate_health=σ(MLP_gate_h([components∥context]))gate_topo=σ(MLP_gate_t([components∥context]))gate_perf=σ(MLP_gate_p([components∥context]))

where [components∥context] denotes the concatenation of the component scores and the context vector. In Step 3, the gated combination may be computed as: PQS_pred=(gate_health·PCPU_Health)×(gate_topo·Topology_Alignment)×(gate_perf·Performance_Realization). In Step 4, the result may be normalized to produce the final placement quality indicator. The multiplicative gated structure preserves the analytical structure of the placement quality formula while permitting learned downweighting of components that are less relevant for a particular workload type.

The placement quality indicator for the mapping of virtual processing unit i to physical processing unit j at time t is:

PQS(vcpu_i→pcpu_j,t)=PCPU_Suitability(j,t)×Topology_Alignment(i,j,t)×Performance_Realization(i,j,t)

where PCPU_Suitability(j,t) is the output of Module 1, Topology_Alignment(i,j,t) is the output of Module 2, and Performance_Realization(i,j,t) is the output of Module 3 of the Integrated Adaptive Edge Weights Module 603. Each component may be produced by a respective differentiable neural layer whose parameters are jointly trained with the graph neural network. The PQS Integration Module 604 combines the three components using the gated integration, in which the gate values scale each component according to its learned relevance for the workload under evaluation, effectively replacing the direct multiplicative product with a context-aware, learned combination.

After processing through the three message passing layers 602 using the adaptive edge weights as attention sources, the node representations may contain multi-hop neighborhood information. For example, the virtual processing unit node representation h_vcpu contains: at the one-hop level, peer virtual processing units of the same virtual machine, the current physical processing unit, and the socket; at the two-hop level, the peers of those peer virtual processing units, the neighbors of the current physical processing unit, and cross-socket information; and at the three-hop level, the full virtual machine structure. The physical processing unit node representation h_pcpu contains: at the one-hop level, neighboring physical processing units, placed virtual processing units, and the socket; and at the two-hop level, two-hop physical processing units, virtual processing units and their neighbors, and cross-socket physical processing units.

The graph neural network architecture shown in FIG. 6 may operates sequentially through multiple layers including these five layers. The node encoding layer 601 may project raw node features into a unified 128-dimensional space. The message passing module 602 may propagate neighborhood information through three heterogeneous message passing layers, with the adaptive edge weights modulating the aggregation between physical processing unit nodes via GRU-updated representations with residual connections. The Integrated Adaptive Edge Weights Module 603 may receive the updated node representations from the message passing module 602 and computes the PCPU suitability, topology alignment, and performance realization components through its three differentiable neural layer sub-modules. The PQS Integration Module 604 may receive the three component scores and produces the placement quality indicator through gated integration with learned gate values. The output of the PQS Integration Module 604 may feed into the output heads 605, which produce the multi-task outputs of the graph neural network, as described further herein.

The analytical formulas for PCPU suitability, topology alignment, and performance realization are implemented as differentiable neural layers within the Integrated Adaptive Edge Weights Module 603 whose parameters are jointly trained with those of the message passing layers 602 and the PQS Integration Module 604, rather than being applied as fixed external computations. This joint training enables the model to learn workload-specific adaptations of each formula during training. In an example, for memory-streaming workloads, the L3 cache health factor within the PCPU_Health_Module may learn a lower contribution weight than for compute-bound workloads, because memory-streaming workloads exhibit lower sensitivity to L3 co-tenancy. The learnable combination step within each sub-module replaces fixed multiplicative coefficients with trained parameters that the model adjusts based on observed placement quality outcomes across different workload types and hardware configurations.

In an example, the at least one differentiable neural layer comprises a performance differentiable neural layer configured to compute a performance metric based on a ratio of an estimated actual performance metric to an estimated expected performance metric for the mapping. The output heads 605 of the graph neural network may generate multiple task-specific outputs from a single forward pass through the network architecture. The processor 202 may generate, based on the processing of the graph data structure, at least one of: a root cause classification indicating a category of placement deficiency, a component attribution indicating a contribution of respective metrics to the placement quality indicator, or a recommendation of at least one alternative physical processing unit for the mapping. The graph neural network can produce multiple (e.g., five) output heads, each dedicated to a distinct diagnostic task, enabling comprehensive assessment of placement quality from a single inference operation. The shared graph neural network layers, comprising the node encoding layer 601, the message passing layers 602, the Integrated Adaptive Edge Weights Module 603, and the PQS Integration Module 604, may provide the representations from which all five output heads produce their respective outputs.

In an example, Head 1 is a PQS prediction head that produces the placement quality indicator as a regression output. The placement quality indicator is a scalar value in the range [0, 1] for each vCPU-to-pCPU mapping under evaluation, where a value approaching 1 indicates a mapping of high placement quality and a value approaching 0 indicates a suboptimal mapping. Head 1 constitutes the primary output of the graph neural network corresponding to the placement quality indicator determined by the processor 202.

In an example, Head 2 is a root cause classification head that produces a root cause classification indicating a category of placement deficiency for a given mapping. The root cause classification head generates a probability distribution over placement deficiency categories. In an example, the classification produces a distribution over multiple (e.g., nine) categories, including L3 cache degradation, L2 contention, topology misalignment, workload mismatch, and good placement. The root cause classification identifies the specific type of deficiency present in the mapping, enabling targeted corrective action directed at the hardware or topological factor responsible.

In an example, Head 3 is a component attribution head that produces a component attribution indicating the contribution of respective metrics to the placement quality indicator. The component attribution output comprises the attribution vector [a_health, a_topo, a_perf], where each element quantifies the percentage of responsibility for the placement quality indicator value attributable to the PCPU health component, the topology alignment component, and the performance realization component respectively. In an example, a component attribution output may indicate seventy percent of the placement quality deficit is attributable to physical processing unit health, twenty percent to topology misalignment, and ten percent to performance realization, enabling a system administrator to identify which hardware or topological factor is the primary driver of suboptimal placement.

In an example, Head 4 is a counterfactual recommendation head that produces a recommendation of at least one alternative physical processing unit for the mapping. The counterfactual recommendation head ranks candidate alternative physical processing units by their predicted placement quality indicator and outputs the top-k candidates with their respective predicted PQS values. In an example, the processor 202 produces the top three alternative physical processing units for a given virtual processing unit, each accompanied by its predicted placement quality score, representing the physical processing units on which the virtual processing unit should have been placed given the observed hardware state. The counterfactual recommendation output provides the target physical processing unit for the migration instruction described herein.

In an example, the processor is further configured to detect, based on the processing, a temporal degradation pattern associated with the mapping, the temporal degradation pattern comprising an indication of when the placement quality indicator transitioned below a threshold during the execution of the workload. In an example, Head 5 is a temporal pattern detection head that identifies degradation in placement quality over the course of workload execution. The temporal pattern detection head outputs a degradation score quantifying the severity of the degradation, a timestamp indicating when the placement quality indicator first transitioned below the threshold during execution, and a trigger type identifying the event or condition that initiated the degradation. Head 5 addresses the fact that placement quality is not static during workload execution: a placement that was initially suitable may become suboptimal due to evolving cache contention, processor load shifts, or migration events that alter the hardware state observed during execution.

In an example, the graph neural network is trained using a multi-task loss function that jointly optimizes a plurality of output objectives comprising at least the placement quality indicator and a classification of a placement deficiency category. The multi-task loss function combines a regression loss for the placement quality indicator prediction of Head 1, a classification loss for the root cause classification of Head 2, an attribution loss for the component attribution of Head 3, a ranking loss for the counterfactual recommendation of Head 4, and a temporal detection loss for the temporal degradation pattern of Head 5. All five output heads are trained jointly with a weighted combination of these individual losses. Joint training with the weighted multi-task loss enables the shared graph neural network layers to learn node representations that simultaneously serve all five output objectives, and enables comprehensive diagnostic capabilities from a single forward pass.

In an example, as depicted in the Integrated Adaptive Edge Weights Module 603 block, each Module may receive the node representations produced by the message passing module 602 and produce a placement quality component score corresponding respectively to the suitability, topology alignment, and performance realization differentiable neural layers. The PQS Integration Module 604 block illustrates the gated integration computation, including the sigmoid-activated gate formulas and the multiplicative gated combination yielding PQS_pred, as described herein. The output heads block 605 may list the multi-task output heads of the graph neural network: PQS Prediction (regression), Root Cause Classification with multiple (e.g., nine) categories, Component Attribution comprising the attribution vector [a_health, a_topo, a_perf], and Counterfactual Recommendation providing the top-three alternative physical processing units, with the temporal pattern detection head described herein completing the set of five output heads produced from a single forward pass.

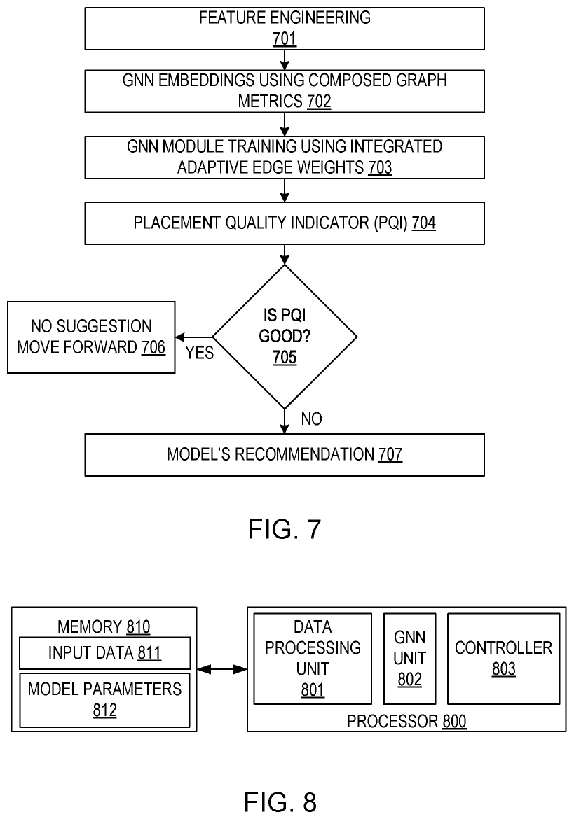

FIG. 7 illustrates an example of an operational process flow, which may be executed by the processor 202 in accordance with various aspects described herein. The process flow includes multiple blocks. The process flow may perform post-processing of the entire workload execution by utilizing metrics obtained through advanced graph techniques and systematically analyzes the data to assess the placement of each virtual processing unit on a physical processing unit, thereby identifying optimal placement strategies.

The flow begins with Feature Engineering block 701 in which the processor 202 acquires all data sources required for graph construction and inference. This acquiring may include hardware topology data obtained from system configuration tables, hardware telemetry logs comprising L2/L3 cache data and CPU utilization metrics from EMON, virtual processing unit metrics from hypervisor/OS telemetry (e.g., resource utilization logs), and placement history data comprising the recorded vCPU-to-pCPU mapping assignments and migration events accumulated during workload execution. Block 701 assembles the node feature vectors for nodes of the first type and nodes of the second type from these respective data sources.

From block 701, the flow can proceed to GNN Embeddings using Composed Graph Metrics block 702, in which the processor 202 constructs the heterogeneous graph composition from the hardware topology and virtual machine assignment data acquired in block 701. Block 702 may produce the physical core graph composition and the virtual core graph composition, each organized into subgraphs corresponding to memory access domains and virtual machines respectively, as described herein. Further, the processor 202 may generate the initial node embeddings from the composed graph metrics using the node encoding layer 601. The adaptive edge weights for edges of the first edge type and edges of the second edge type may be computed from the hardware telemetry data and placement history assembled in block 701 and assigned to the edges of the graph data structure.

The flow can then proceed to GNN Module Training using Integrated Adaptive Edge Weights block 703, in which the processor 202 processes the graph data structure comprising the adaptive edge weights through the graph neural network, which may include the message passing module 602, the Integrated Adaptive Edge Weights Module 603, and the PQS Integration Module 604 described herein. The graph neural network modules may be trained to calculate the placement quality indicator for analyzing and predicting wrong virtual processing unit placements on physical processing units: the model both analyses recorded placements from the placement history assembled in block 701 and predict whether a given vCPU-to-pCPU mapping may be suboptimal given the hardware state observed at the corresponding epoch. The training of the graph neural network in block 703 uses the integrated adaptive edge weights as learnable modules, jointly optimized with the multi-task loss function described herein, enabling the model to learn workload-specific adaptations of the placement quality formulas.

Block 703 produces as output the Placement Quality Indicator (PQI) block 704, which includes the placement quality indicator described herein, which may be a scalar value in the range [0, 1] for each virtual processing unit to physical processing unit mapping under evaluation. The flow may then reach decision block 705, labeled “Is PQI Good?”, which evaluates whether the placement quality indicator 704 meets a quality threshold. Where the placement quality indicator 704 is above the threshold, the Yes branch leads to No Suggestion/Move Forward block 706, confirming the current placement as acceptable and identifying it as an optimal placement strategy requiring no corrective action. Where the placement quality indicator 704 is below the threshold, the No branch leads to Model's Recommendation block 707, which may produce the counterfactual recommendation, root cause classification, component attribution, and/or temporal degradation pattern outputs, and may further trigger a migration instruction to the hypervisor 160.

With the involvement of the operational process flow of FIG. 7, the generic classification model and flat feature preparation of the existing flow can be replaced by the heterogeneous graph composition and adaptive edge computation of blocks 701 and 702 and by the graph neural network of block 703 trained using integrated adaptive edge weights, which produces, rather than a binary valid-or-invalid classification, the quantitative placement quality indicator 704 together with root cause classification, component attribution, counterfactual recommendation, and temporal degradation pattern outputs from a single forward pass.

FIG. 8 shows schematically an example of a processor and a memory to implement a graph neural network (GNN) in accordance with various aspects provided herein. The processor 800 is depicted to include various functional units that are configured to provide various functions as disclosed herein, associated with the processor 202 or the one or more processors 102. The skilled person would recognize that the depicted functional units are provided to explain various operations that the processor 800 may be configured to perform. Similarly, the memory 810 (e.g., the memory 202) is depicted to include the input data 811 as a block, however, the memory 810 may store the input data 811 in any kind of suitable configuration or mechanism.

The “input data” may refer to or may include the data to be inputted to the GNN model in accordance to aspects described herein. In various examples, the input data may include a graph as described herein, which includes a two dimensional representation of nodes, edges, node embeddings, as described herein. In the context of the present disclosure, the output data may include the placement quality indicator, the root cause classification, the component attribution, the counterfactual recommendation of at least one alternative physical processing unit, and the temporal degradation pattern, as described herein.

Furthermore, the GNN unit 802 is depicted as it is implemented in the processor 800 only as an example, and any type of GNN implementation which may include the implementation of the GNN model in an external processor, such as an accelerator, a graphics processing unit (GPU), a neuromorphic chip, or in a cloud computing device, or in an external processing device may also be possible according to any methods.

The processor 800 may include a data processing unit 801 that is configured to process data and obtain input of the GNN unit based on the input data 811 as provided in various examples in this disclosure to be stored in the memory 810. In various examples, the input data 811 may include data of not only current but also past information for at least within a period of time in a plurality of instances of time (e.g., as a time-series data).

The data processing unit 801 may implement various preprocessing operations to obtain the input. Such operations may include cleaning the input data 811 by removing outliers, handling of missing parameters, correcting errors or inconsistencies, and such. Operations may further include data normalizations in order to scale the input data 811 to a common range. Operations may further include data transformation including mapping the input data 811 based on predefined mapping operations corresponding to mathematical functions to map one or more data items of the input data 811 to a mapped data time for the purpose of analysis. Illustratively, the data processing unit 801 may act as a front end for processing of the graph data structure.

The data processing unit 801 may be configured to generate training dataset based on the input data 811. In other words, based output of the GNN unit 802 in response to the input of the GNN model, the data processing unit 801 may prepare the training data to be used in the training of the GNN model. The data processing unit 801 may be configured to apply data fusion techniques to aggregate data. Data fusion may be considered as a process of integrating and combining data, within this context, by combining the input data 811 to obtain a unified dataset.

The data processing unit 801 may further implement feature extraction operations. It is to be considered that the GNN model implemented by the GNN unit 802 may have certain constraints, some of which may relate to the structure and aspects of the data to be inputted to the GNN. The feature extraction operations may include translating (i.e., transforming) the input data 811 into input of the GNN model. The feature extraction operations may further include generation of training input data for the training dataset based on the input data 811. In some aspects, the feature extraction operations may be based on model information representing the attributes to be used as the input of the GNN model, relative importance or weights of the attributes, etc. The feature extraction operations may include reducing the number of attributes (i.e., data items from the input data 811) to be used, ranking of the attributes, etc. based on the model information.

In some aspects, the input data 811 may include information representative of annotations and/or labels to be used for training. In some aspects, the data processing unit 801 may also assign labels or assign ground truth values for the generated training data for the generation of the training dataset. In some aspects, the data processing unit 801 may further generate annotations for the generation of the training data set. Generation of annotations and/or labels may be according to supervised training inputs, or may be based on unsupervised methods, exemplarily by an implementation of an automatized model to assign the labels and/or the annotations. In the context of the present disclosure, ground truth labels for the placement quality indicator may be derived from historical vCPU-to-pCPU placement records annotated with observed performance outcomes, and ground truth labels for root cause classification may be assigned based on hardware counter threshold rules applied to the corresponding EMON log data.

It is to be noted that the GNN unit 802 may use the training dataset in predefined portions, namely a first portion of the training data set for training, a second portion of the training dataset for validation and a third portion of the training dataset for testing purposes. The GNN unit 802 may use the first portion to train the GNN model, which may allow the GNN to learn the underlying patterns and relationships in the data. The GNN unit 802 may use the second portion to evaluate and fine-tune the GNN model during the training process, which may help to prevent overfitting and improve generalization. Finally, the GNN unit 802 may use the third portion to assess the performance of the trained GNN model and provide an unbiased estimate of their accuracy and effectiveness for GNN model tasks.

The GNN unit 802 may implement one or more GNN models. As described herein, the GNN unit 802 implements the GNN, which may include the message passing module 602 for heterogeneous message passing, the Integrated Adaptive Edge Weights Module 603 comprising the suitability, topology alignment, and performance realization differentiable neural layers, the PQS Integration Module 604 for gated integration of placement quality components, and the multi-task output heads 605 for generating the placement quality indicator, root cause classification, component attribution, counterfactual recommendation, and temporal degradation pattern. The GNN model may be configured to receive the input with certain constraints, features, and formats. Accordingly, the data processing unit 801 may obtain the input of the GNN, that is based on the input data 811, to be provided to the GNN model to obtain an output of the GNN model. In various examples, the data processing unit 801 may provide input data including the input data 811 to the GNN model. The input of the GNN may model include attributes of the input data 811 associated with a period of time or a plurality of consecutive periods of time. In various examples, the data processing unit 801 may convert the input data 811 to an input format suitable for the GNN model (i.e., feature extraction e.g., to input feature vectors) so that the GNN model may process the input data 811. It is to be noted that the input of the GNN model may naturally include data, though the term input of the GNN has been used to distinguish from the term “input data”.

The processor 800 may further include a controller 803 to control the GNN unit 802. The controller 803 may provide the input to the GNN model, or provide the GNN unit 802 instructions to obtain the output. The controller 803 may further be configured to perform further operations of the processor 800 in accordance with various aspects of this disclosure.

The GNN model may be any type of machine learning model configured to receive the input of the GNN model and provide an output as provided in this disclosure. The GNN model may stand for the ML-based application provided in the disclosure. The GNN model may include a neural network. The neural network may be any type of artificial neural network. The neural network may include any number of layers, including an input layer to receive the input of the GNN model, an output layer to provide the output data. A number of layers may be provided between the input layer and the output layer (e.g., hidden layers). The training of the neural network (e.g., adapting the layers of the neural network, adjusting model parameters 812) may use or may be based on any kind of training principle, such as backpropagation (e.g., using the backpropagation algorithm).

For example, the neural network may be a feed-forward neural network in which the information is transferred from lower layers of the neural network close to the input to higher layers of the neural network close to the output. Each layer may include neurons that receive input from a previous layer and provide an output to a next layer based on certain GNN model (e.g., weights) parameters 812 adjusting the input information. In various examples, the neural network may be configured in top-down configuration in which a neuron of a layer provides output to a neuron of a lower layer, which may help to discriminate certain features of an input.

The GNN model may include a recurrent neural network in which neurons transfer the information in a configuration in which the neurons may transfer the input information to a neuron of the same layer. Recurrent neural networks (RNNs) may help to identify patterns between a plurality of input sequences, and accordingly, RNNs may be used to identify, in particular, a temporal pattern provided with time-series data and perform estimations based on the identified temporal patterns. In various examples of RNNs, long short-term memory (LSTM) architecture may be implemented. The LSTM networks may be helpful to perform classifications, processing, and estimations using time series data.

An LSTM network may include a network of LSTM cells that may process the attributes provided for an instance of time as input of the GNN model, such as attributes provided for the instance of time, and one or more previous outputs of the LSTM that have taken in place in previous instances of time, and accordingly, obtain the output data. The number of the one or more previous inputs may be defined by a window size, and the weights associated with each previous input may be configured separately. The window size may be arranged according to the processing, memory, and time constraints and the input of the GNN model. The LSTM network may process the features of the received raw data and determine a label for an attribute for each instance of time according to the features. The output data may include or represent a label associated with the input of the GNN model.

In accordance with various aspects, the GNN model may include a reinforcement learning model. The reinforcement learning model may be modeled as a Markov decision process (MDP). The MDP may determine an action from an action set based on a previous observation which may be referred to as a state. In a next state, the MDP may determine a reward based on the current state that may be based on current observations and the previous observations associated with previous state. The determined action may influence the probability of the MDP to move into the next state. Accordingly, the MDP may obtain a function that maps the current state to an action to be determined with the purpose of maximizing the rewards. Accordingly, input of the GNN model for a reinforcement learning model may include information representing a state, and an output data may include information representing an action.

Reinforcement learning (RL) is a type of machine learning that focuses on training an agent to make decisions by interacting with an environment. The agent learns to perform actions to achieve a goal by receiving feedback in the form of rewards or penalties. As a machine learning model, reinforcement learning models learn from data (in this case, the agent's experiences and interactions with the environment) to adapt their behavior and improve their performance over time. Since machine learning is a subset of AI, reinforcement learning models are also considered AI models, as they aim to perform tasks that require human-like decision-making capabilities.

The GNN model may include a convolutional neural network (CNN), which is an example for feed-forward neural networks that may be used for the purpose of this disclosure, in which one or more of the hidden layers of the neural network include one or more convolutional layers that perform convolutions for their received input from a lower layer. The CNNs may be helpful for pattern recognition and classification operations. The CNN may further include pooling layers, fully connected layers, and normalization layers.

The GNN model may include a generative neural network. The generative neural network may process input of the GNN model in order to generate new sets, hence the output data may include new sets of data according to the purpose of the GNN model. In various examples, the GNN model may include a generative adversarial network (GAN) model in which a discrimination function is included with the generation function, and while the generation function may generate the data according to model parameters 812 of the generation function and the input of the GNN model, the discrimination function may distinguish the data generated by the generation function in terms of data distribution according to model parameters 812 of the discrimination function. Provided as example herein, the GNN model may be implemented as a heterogeneous message passing graph neural network (MPGNN) as described herein, in which the node representations are iteratively updated through aggregation over neighboring nodes with the adaptive edge weights modulating the aggregation between nodes of the first type.

The GNN model may include a trained GNN model (e.g., the model parameters 812 in a memory are already set for the purpose) that is configured to provide the output as provided in various examples in this disclosure based on the input of the GNN model and one or more model parameters 812. The trained GNN model may be obtained via an online and/or offline training. A training agent may perform various operations with respect to the training at various aspects, including online training, offline training, and optimizations based on the inference results. The GNN model may take any suitable form or utilize any suitable technique for training process. For example, the GNN model may be trained using supervised learning, semi-supervised learning, unsupervised learning, or reinforcement learning techniques.

For supervised learning, generation of labels and annotations may require domain expertise and an understanding of the specific tasks that the GNN is designed to address. For example, a human expert or an automated rule-based system may review EMON logs and scheduler logs to assign ground truth placement quality scores and root cause classification labels for each recorded vCPU-to-pCPU mapping, which may then be used as training examples for the graph neural network described herein. In some cases, semi-supervised or unsupervised learning techniques can be used to reduce the reliance on labeled data. These approaches may involve clustering, anomaly detection, or other methods that can identify patterns and relationships in the data without explicit ground truth labels.

In supervised learning, the GNN model may be obtained using a training dataset including both inputs and corresponding desired outputs (illustratively, input data may be associated with a desired or expected output for that input data). Each training instance may include one or more input data item and a desired output. The training agent may train the GNN model based on iterations through training instances and using an objective function to teach the GNN model to estimate the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training dataset including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive feedback (also referred to as reward) or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The training agent may adjust the model parameters 812 of the respective model based on outputs and inputs (i.e., output data and input data). The training agent may train the GNN model according to the desired outcome. The training agent may provide the training data to the GNN model. In various examples, the processor 800 and/or the GNN unit 802 itself may include the training agent, or another entity that may be communicatively coupled to the processor may include the training agent and provide the training data to the device, so that the processor may train the GNN model.

The GNN model may include an execution unit and a training unit that may implement the training agent as provided in this disclosure for other examples. In accordance with various examples, the training agent may train the GNN model based on a simulated environment that is controlled by the training agent according to similar considerations and constraints of the deployment environment.

The skilled person would immediately recognize that the exemplary GNN model disclosed herein is explained that may have many configurations. In an example scenario, for execution of the GNN model (i.e., inference), the GNN may be configured to provide an output as described in the examples of the output data. For training of the GNN model, the training agent may train the GNN model by providing training input data of the generated training dataset to the input of the GNN. The training agent may adjust model parameters 812 of the GNN model based on the output of the GNN model that is mapped according to the training input data, and training output data of the training dataset (e.g., labels, annotations) associated with the provided training input data with an intention to make the output of the GNN more accurate. In this constellation, the training input data may include predefined or predetermined data representing examples provided for the input data in different configuration and/or scenarios (e.g., generated with simulations, generated based on past records) and the training output data may include corresponding predefined or predetermined data representing examples provided for the output data, each corresponding to a respective training input data.

Accordingly, the training agent may adjust one or more model parameters 812 based on a calculation including parameters for the output of the GNN model for the training input data and the training output data associated with the training input data. In various examples, the calculation may also include one or more parameters of the GNN model. With each iteration with respect to the training input data that may include many data items, which each data item may represent an input of an instance (of time, of observation, etc.) on various aspects and each iteration may iterate a respective data item representing an input of an instance, the training agent may accordingly cause the GNN to provide more accurate output through adjustments made in the model parameters 812.

The processor 800 may implement the training agent, or another entity that may be communicatively coupled to the processor 800 may include the training agent and provide the training input data to the device, so that the processor 800 may train the GNN model. The training agent may be part of the GNN unit 802 described herein. Furthermore, the controller 803 may control the GNN unit 802 according to a predefined event. For example, the controller 803 may provide instructions to the GNN unit 802 to perform the inference and/or training in response to a received request from another entity. The controller 803 may further obtain output of the GNN model from the GNN unit 802.

In the context of the present disclosure, the training agent adjusts the model parameters 812 of the graph neural network to minimize the weighted multi-task loss function described herein, which jointly optimizes the regression loss for the placement quality indicator, the classification loss for the root cause classification, the attribution loss for the component attribution, the ranking loss for the counterfactual recommendation, and the temporal detection loss for the temporal degradation pattern. The training input data may comprise heterogeneous graph data structures constructed from historical workload execution records, with the adaptive edge weights computed from the corresponding EMON and hypervisor/OS telemetry (e.g., hypervisor resource utilization telemetry logs), and the training output data may comprise the corresponding ground truth placement quality scores, root cause categories, and attribution vectors.

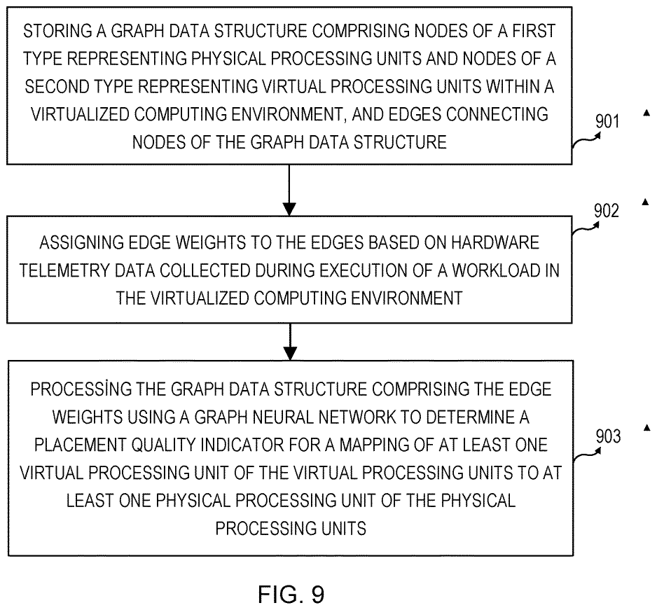

FIG. 9 shows an example of a method. The method may include: storing 901 a graph data structure including nodes of a first type representing physical processing units and nodes of a second type representing virtual processing units within a virtualized computing environment, and edges connecting nodes of the graph data structure; assigning 902 edge weights to the edges based on hardware telemetry data collected during execution of a workload in the virtualized computing environment; and processing 903, by a processor, the graph data structure including the edge weights using a graph neural network to determine a placement quality indicator for a mapping of at least one virtual processing unit of the virtual processing units to at least one physical processing unit of the physical processing units.

The detailed description refers to the accompanying drawings that show, by way of illustration, specific details and aspects of this disclosure in which the disclosure may be practiced. Other aspects may be utilized and structural, logical, and electrical changes may be made without departing from the scope of the disclosure. The various aspects of this disclosure are not necessarily mutually exclusive, as some aspects of this disclosure can be combined with one or more other aspects of this disclosure to form new aspects.

Throughout the drawings, it should be noted that like reference numbers are used to depict the same or similar elements, features, and structures, unless otherwise noted.

The word “exemplary” is used herein to mean “serving as an example, instance, or illustration”. Any aspect or design described herein as “exemplary” is not necessarily to be construed as preferred or advantageous over other aspects or designs.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As utilized herein, terms “module”, “component,” “system,” “circuit,” “element,” “slice,” “circuitry,” and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term “set” can be interpreted as “one or more.”

It will be understood that when an element is referred to as being “connected” or “coupled” to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “applied” to an element, the voltage, current, or signal may be conducted to the element by way of a physical connection or by way of capacitive, electro-magnetic, or inductive coupling that does not involve a physical connection.

The following examples pertain to further aspects of this disclosure.

Example 1 includes the subject matter of an apparatus including: a memory configured to store a graph data structure including nodes of a first type representing physical processing units and nodes of a second type representing virtual processing units within a virtualized computing environment, and edges connecting nodes of the graph data structure; and a processor configured to: assign edge weights to the edges based on hardware telemetry data collected during execution of a workload in the virtualized computing environment; and process the graph data structure including the edge weights using a graph neural network to determine a placement quality indicator for a mapping of at least one virtual processing unit of the virtual processing units to at least one physical processing unit of the physical processing units.

Example 2 includes the subject matter of example 1, wherein the edge weights are calculated based on the hardware telemetry data at successive time intervals during the execution of the workload.

Example 3 includes the subject matter of example 1 or example 2, wherein the nodes of the first type and the nodes of the second type are associated with respective feature vectors of different dimensionalities derived from different data sources.

Example 4 includes the subject matter of any one of examples 1 to 3, wherein the graph data structure includes a first graph composition including the nodes of the first type and a second graph composition including the nodes of the second type.

Example 5 includes the subject matter of example 4, wherein the first graph composition includes a plurality of subgraphs, each subgraph of the first graph composition corresponding to a respective memory access domain of the virtualized computing environment.

Example 6 includes the subject matter of example 4 or example 5, wherein the second graph composition includes a plurality of subgraphs, each subgraph of the second graph composition corresponding to a respective virtual machine executing in the virtualized computing environment.

Example 7 includes the subject matter of any one of examples 4 to 6, wherein edges within the second graph composition connect nodes of the second type that belong to a same virtual machine.

Example 8 includes the subject matter of any one of examples 1 to 7, wherein the edges include edges of a first edge type connecting pairs of nodes of the first type and edges of a second edge type connecting pairs of nodes of the second type.

Example 9 includes the subject matter of example 8, wherein the edge weights for edges of the first edge type are computed as a product of a static weight component based on a topological distance between the corresponding physical processing units and at least one metric derived from the hardware telemetry data.

Example 10 includes the subject matter of example 9, wherein the at least one metric includes a cache health metric determined from cache performance counters associated with the corresponding physical processing units.

Example 11 includes the subject matter of example 10, wherein the cache health metric includes separate metrics corresponding to respective cache levels of the physical processing units.

Example 12 includes the subject matter of any one of examples 9 to 11, wherein the at least one metric includes a resource contention metric indicating a degree of contention for execution resources between the corresponding physical processing units.

Example 13 includes the subject matter of any one of examples 8 to 12, wherein the edge weights for edges of the second edge type are based on a ratio of a shared memory quantity between corresponding virtual processing units to a distance between physical processing units to which the corresponding virtual processing units are mapped.

Example 14 includes the subject matter of any one of examples 1 to 13, wherein the feature vectors associated with the nodes of the first type are derived from hardware performance counter data and the feature vectors associated with the nodes of the second type are derived from scheduler and virtual machine metrics.

Example 15 includes the subject matter of any one of examples 1 to 14, wherein the graph neural network includes a plurality of message passing layers configured to aggregate information from neighboring nodes, wherein the edge weights modulate aggregation between nodes of the first type.

Example 16 includes the subject matter of any one of examples 1 to 15, wherein the graph neural network includes at least one differentiable neural layer configured to compute a placement quality metric from embeddings of the nodes and the edge weights, and wherein parameters of the at least one differentiable layer are jointly trained with parameters of the graph neural network.

Example 17 includes the subject matter of example 16, wherein the at least one differentiable layer includes a suitability differentiable neural layer configured to compute a suitability metric for a physical processing unit based on the edge weights and a current load of the physical processing unit.

Example 18 includes the subject matter of example 16 or example 17, wherein the at least one differentiable layer includes a topology alignment differentiable neural layer configured to compute an alignment metric indicating a degree to which virtual processing units of a same virtual machine are mapped to topologically proximate physical processing units.

Example 19 includes the subject matter of any one of examples 16 to 18, wherein the at least one differentiable neural layer includes a performance differentiable neural layer configured to compute a performance metric based on a ratio of an estimated actual performance metric to an estimated expected performance metric for the mapping.

Example 20 includes the subject matter of any one of examples 16 to 19, wherein the processor is further configured to combine outputs of the at least one differentiable neural layer using a gated integration including learned gate values that determine a relative contribution of each placement quality component to the placement quality indicator.

Example 21 includes the subject matter of any one of examples 1 to 20, wherein the processor is further configured to generate, based on the processing, at least one of: a root cause classification indicating a category of placement deficiency, a component attribution indicating a contribution of respective metrics to the placement quality indicator, or a recommendation of at least one alternative physical processing unit for the mapping.

Example 22 includes the subject matter of any one of examples 1 to 21, wherein the processor is further configured to detect, based on the processing, a temporal degradation pattern associated with the mapping, the temporal degradation pattern including an indication of when the placement quality indicator transitioned below a threshold during the execution of the workload.

Example 23 includes the subject matter of any one of examples 1 to 22, wherein the graph neural network is trained using a multi-task loss function that jointly optimizes a plurality of output objectives including at least the placement quality indicator and a classification of a placement deficiency category.

Example 24 includes the subject matter of any one of examples 1 to 23, wherein the processor is configured to process the graph data structure as a post-processing operation after completion of at least a portion of the execution of the workload.

Example 25 includes the subject matter of any one of examples 1 to 24, wherein the processor is further configured to send an instruction to at least one of a hypervisor or a further physical processing unit of the physical processing unit to cause the at least one virtual processing unit to be migrated from the at least one physical processing unit to the further physical processing unit based on the placement quality indicator.

Example 26 includes a computing system including: the apparatus of any one of examples 1 to 25; and the plurality of physical processing units.

Example 27 includes the subject matter of a method including: storing a graph data structure including nodes of a first type representing physical processing units and nodes of a second type representing virtual processing units within a virtualized computing environment, and edges connecting nodes of the graph data structure; assigning edge weights to the edges based on hardware telemetry data collected during execution of a workload in the virtualized computing environment; and processing, by a processor, the graph data structure including the edge weights using a graph neural network to determine a placement quality indicator for a mapping of at least one virtual processing unit of the virtual processing units to at least one physical processing unit of the physical processing units.

Example 28 includes the subject matter of example 27, wherein the edge weights are calculated based on the hardware telemetry data at successive time intervals during the execution of the workload.

Example 29 includes the subject matter of example 27 or example 28, wherein the nodes of the first type and the nodes of the second type are associated with respective feature vectors of different dimensionalities derived from different data sources.

Example 30 includes the subject matter of any one of examples 27 to 29, wherein the graph data structure includes a first graph composition including the nodes of the first type and a second graph composition including the nodes of the second type.

Example 31 includes the subject matter of example 30, wherein the first graph composition includes a plurality of subgraphs, each subgraph of the first graph composition corresponding to a respective memory access domain of the virtualized computing environment.

Example 32 includes the subject matter of example 30 or example 31, wherein the second graph composition includes a plurality of subgraphs, each subgraph of the second graph composition corresponding to a respective virtual machine executing in the virtualized computing environment.

Example 33 includes the subject matter of any one of examples 30 to 32, wherein edges within the second graph composition connect nodes of the second type that belong to a same virtual machine.

Example 34 includes the subject matter of any one of examples 27 to 33, wherein the edges include edges of a first edge type connecting pairs of nodes of the first type and edges of a second edge type connecting pairs of nodes of the second type.

Example 35 includes the subject matter of example 34, wherein the edge weights for edges of the first edge type are computed as a product of a static weight component based on a topological distance between the corresponding physical processing units and at least one metric derived from the hardware telemetry data.

Example 36 includes the subject matter of example 35, wherein the at least one metric includes a cache health metric determined from cache performance counters associated with the corresponding physical processing units.

Example 37 includes the subject matter of example 36, wherein the cache health metric includes separate metrics corresponding to respective cache levels of the physical processing units.

Example 38 includes the subject matter of any one of examples 35 to 37, wherein the at least one metric includes a resource contention metric indicating a degree of contention for execution resources between the corresponding physical processing units.

Example 39 includes the subject matter of any one of examples 34 to 38, wherein the edge weights for edges of the second edge type are based on a ratio of a shared memory quantity between corresponding virtual processing units to a distance between physical processing units to which the corresponding virtual processing units are mapped.

Example 40 includes the subject matter of any one of examples 27 to 39, wherein the feature vectors associated with the nodes of the first type are derived from hardware performance counter data and the feature vectors associated with the nodes of the second type are derived from scheduler and virtual machine metrics.

Example 41 includes the subject matter of any one of examples 27 to 40, wherein the graph neural network includes a plurality of message passing layers configured to aggregate information from neighboring nodes, wherein the edge weights modulate aggregation between nodes of the first type.

Example 42 includes the subject matter of any one of examples 27 to 41, wherein the graph neural network includes at least one differentiable neural layer configured to compute a placement quality metric from embeddings of the nodes and the edge weights, and wherein parameters of the at least one differentiable layer are jointly trained with parameters of the graph neural network.

Example 43 includes the subject matter of example 42, wherein the at least one differentiable layer includes a suitability differentiable neural layer configured to compute a suitability metric for a physical processing unit based on the edge weights and a current load of the physical processing unit.

Example 44 includes the subject matter of example 42 or example 43, wherein the at least one differentiable layer includes a topology alignment differentiable neural layer configured to compute an alignment metric indicating a degree to which virtual processing units of a same virtual machine are mapped to topologically proximate physical processing units.

Example 45 includes the subject matter of any one of examples 42 to 44, wherein the at least one differentiable neural layer includes a performance differentiable neural layer configured to compute a performance metric based on a ratio of an estimated actual performance metric to an estimated expected performance metric for the mapping.

Example 46 includes the subject matter of any one of examples 42 to 45, may further include combining, by the processor, outputs of the at least one differentiable neural layer using a gated integration including learned gate values that determine a relative contribution of each placement quality component to the placement quality indicator.

Example 47 includes the subject matter of any one of examples 27 to 46, may further include generating, by the processor based on the processing, at least one of: a root cause classification indicating a category of placement deficiency, a component attribution indicating a contribution of respective metrics to the placement quality indicator, or a recommendation of at least one alternative physical processing unit for the mapping.

Example 48 includes the subject matter of any one of examples 27 to 47, may further include detecting, by the processor based on the processing, a temporal degradation pattern associated with the mapping, the temporal degradation pattern including an indication of when the placement quality indicator transitioned below a threshold during the execution of the workload.

Example 49 includes the subject matter of any one of examples 27 to 48, wherein the graph neural network is trained using a multi-task loss function that jointly optimizes a plurality of output objectives including at least the placement quality indicator and a classification of a placement deficiency category.

Example 50 includes the subject matter of any one of examples 27 to 49, wherein processing the graph data structure includes processing the graph data structure as a post-processing operation after completion of at least a portion of the execution of the workload.

Example 51 includes the subject matter of any one of examples 27 to 50, may further include sending, by the processor, an instruction to at least one of a hypervisor or a further physical processing unit of the physical processing unit to cause the at least one virtual processing unit to be migrated from the at least one physical processing unit to the further physical processing unit based on the placement quality indicator.

Example 52 includes a non-transitory computer-readable medium including instructions which, when executed by a processor, cause the processor to perform the method of any one of examples 27 to 50.

Example 53 includes an apparatus including means to perform the method of any one of examples 27 to 50.

What is claimed is:

1. An apparatus comprising:
a memory configured to store a graph data structure comprising nodes of a first type representing physical processing units and nodes of a second type representing virtual processing units within a virtualized computing environment, and edges connecting nodes of the graph data structure; and
a processor configured to:
assign edge weights to the edges based on hardware telemetry data collected during execution of a workload in the virtualized computing environment; and
process the graph data structure comprising the edge weights using a graph neural network to determine a placement quality indicator for a mapping of at least one virtual processing unit of the virtual processing units to at least one physical processing unit of the physical processing units.

2. The apparatus of claim 1, wherein the edge weights are calculated based on the hardware telemetry data at successive time intervals during the execution of the workload.

3. The apparatus of claim 1, wherein the nodes of the first type and the nodes of the second type are associated with respective feature vectors of different dimensionalities derived from different data sources.

4. The apparatus of claim 1, wherein the graph data structure comprises a first graph composition comprising the nodes of the first type and a second graph composition comprising the nodes of the second type.

5. The apparatus of claim 4, wherein the first graph composition comprises a plurality of subgraphs, each subgraph of the first graph composition corresponding to a respective memory access domain of the virtualized computing environment.

6. The apparatus of claim 4, wherein the second graph composition comprises a plurality of subgraphs, each subgraph of the second graph composition corresponding to a respective virtual machine executing in the virtualized computing environment.

7. The apparatus of claim 4, wherein edges within the second graph composition connect nodes of the second type that belong to a same virtual machine.

8. The apparatus of claim 1, wherein the edges comprise edges of a first edge type connecting pairs of nodes of the first type and edges of a second edge type connecting pairs of nodes of the second type.

9. The apparatus of claim 8, wherein the edge weights for edges of the first edge type are computed as a product of a static weight component based on a topological distance between the corresponding physical processing units and at least one metric derived from the hardware telemetry data.

10. The apparatus of claim 9, wherein the at least one metric comprises at least one of: a cache health metric determined from cache performance counters associated with the corresponding physical processing units, or a resource contention metric indicating a degree of contention for execution resources between the corresponding physical processing units.

11. The apparatus of claim 1, wherein the feature vectors associated with the nodes of the first type are derived from hardware performance counter data and the feature vectors associated with the nodes of the second type are derived from scheduler and virtual machine metrics.

12. The apparatus of claim 1, wherein the graph neural network comprises at least one differentiable neural layer configured to compute a placement quality metric from embeddings of the nodes and the edge weights.

13. The apparatus of claim 12, wherein the at least one differentiable neural layer comprises at least one of: i) a suitability differentiable neural layer configured to compute a suitability metric for a physical processing unit based on the edge weights and a current load of the physical processing unit; ii) a topology alignment differentiable neural layer configured to compute an alignment metric indicating a degree to which virtual processing units of a same virtual machine are mapped to topologically proximate physical processing units; or iii) a performance differentiable neural layer configured to compute a performance metric based on a ratio of an estimated actual performance metric to an estimated expected performance metric for the mapping.

14. The apparatus of claim 12, wherein the processor is further configured to combine outputs of the at least one differentiable neural layer using a gated integration comprising learned gate values that determine a relative contribution of each placement quality component to the placement quality indicator.

15. The apparatus of claim 1, wherein the processor is further configured to generate, based on the processing, at least one of: a root cause classification indicating a category of placement deficiency, a component attribution indicating a contribution of respective metrics to the placement quality indicator, or a recommendation of at least one alternative physical processing unit for the mapping.

16. The apparatus of claim 1, wherein the processor is further configured to send an instruction to at least one of a hypervisor or a further physical processing unit of the physical processing unit to cause the at least one virtual processing unit to be migrated from the at least one physical processing unit to the further physical processing unit based on the placement quality indicator.

17. A computing system comprising:
an apparatus comprising:
a memory configured to store a graph data structure comprising nodes of a first type representing physical processing units and nodes of a second type representing virtual processing units within a virtualized computing environment, and edges connecting nodes of the graph data structure; and
a processor configured to:
assign edge weights to the edges based on hardware telemetry data collected during execution of a workload in the virtualized computing environment; and
process the graph data structure comprising the edge weights using a graph neural network to determine a placement quality indicator for a mapping of at least one virtual processing unit of the virtual processing units to at least one physical processing unit of the physical processing units; and
the plurality of physical processing units.

18. The computing system of claim 17, wherein the processor is further configured to send an instruction to at least one of a hypervisor or a further physical processing unit of the physical processing unit to cause the at least one virtual processing unit to be migrated from the at least one physical processing unit to the further physical processing unit based on the placement quality indicator.

19. A non-transitory computer-readable medium comprising instructions which, when executed by a processor, cause the processor to:
store a graph data structure comprising nodes of a first type representing physical processing units and nodes of a second type representing virtual processing units within a virtualized computing environment, and edges connecting nodes of the graph data structure;
assign edge weights to the edges based on hardware telemetry data collected during execution of a workload in the virtualized computing environment; and
process, by a processor, the graph data structure comprising the edge weights using a graph neural network to determine a placement quality indicator for a mapping of at least one virtual processing unit of the virtual processing units to at least one physical processing unit of the physical processing units.

20. The non-transitory computer-readable medium of claim 19, wherein the edge weights are calculated based on the hardware telemetry data at successive time intervals during the execution of the workload.
